(19) United States
(12) Patent Application Publication
(10) Pub. No.: US 2020/0158187 A1
(43) Pub. Date: May 21, 2020

(54) POWER TRANSMISSION DEVICE

(71) Applicant: AISIN SEIKI KABUSHIKI KAISHA, Kariya-shi (JP)

(72) Inventors: Atsushi Kajikawa, Kariya-shi (JP); Hiroki Monji, Kariya-shi (JP); Tetsuya Yoshida, Kariya-shi (JP)

(73) Assignee: AISIN SEIKI KABUSHIKI KAISHA, Kariya-shi (JP)

(21) Appl. No.: 16/688,021

(22) Filed: Nov. 19, 2019

(30) Foreign Application Priority Data
Nov. 21, 2018 (JP) 2018-218293
Apr. 16, 2019 (JP) 2019-077791

(51) Int. Cl. F16D 23/06; B60K 6/547; B60L 15/20; B60W 10/08; F16H 61/68

(52) U.S. Cl. CPC F16D 23/06; B60K 6/547; F16H 61/68; B60W 10/08; B60L 15/20

(57) ABSTRACT

A power transmission device includes: a first rotating member rotated by power transmitted from a prime mover; a second rotating member rotating relative to the first rotating member; a first engagement member rotating integrally with the second rotating member at all times; a second engagement member pressed toward the first engagement member; and a moving member rotating integrally with the first rotating member at all times, separated from the first and second engagement members at an initial position, causing the second engagement member to rotate integrally with the first rotating member at a first preparation position where the moving member has moved from the initial position, and causing the second rotating member to rotate integrally with the first rotating member at a first switching position where the moving member has moved from the first preparation position.

### CROSS REFERENCE TO RELATED APPLICATIONS

This application is based on and claims priority under 35 U.S.C. § 119 to Japanese Patent Applications 2018-218293 and 2019-077791, filed on Nov. 21, 2018 and Apr. 16, 2019, respectively, the entire contents of which are incorporated herein by reference.

### TECHNICAL FIELD

The technique that is disclosed in the present application relates to a power transmission device transmitting power input from one rotating member to another rotating member.

### BACKGROUND DISCUSSION

The power transmission device that is disclosed in JP 2017-150587A is known as a power transmission device transmitting power input from one rotating member to another rotating member. As illustrated in FIG. 23, the power transmission device disclosed in JP 2017-150587A includes a rotary shaft 1, a rotation absorption mechanism 4, and a first gear 2 and a second gear 3 rotating relative to the rotary shaft 1 with the rotary shaft 1 inserted through the first gear 2 and the second gear 3 (the rotary shaft 1 is inserted through the first gear 2 and the second gear 3). The rotation absorption mechanism 4 includes a sleeve 4a integrally rotating by the rotary shaft 1 being inserted through the sleeve 4a and the sleeve 4a meshing with the rotary shaft 1, a sleeve holder 4b accommodating the sleeve 4a, a friction plate 4c provided on the sleeve 4a with the sleeve 4a sandwiched between the sleeve holder 4b and the friction plate 4c, and a pressure member 4e attached to the sleeve holder 4b and pressing the friction plate 4c toward the sleeve 4a by means of a spring 4d.

In the power transmission device having such a configuration, the rotary shaft 1 and the first gear 2 (and the second gear 3) rotate relative to each other in the neutral state that is illustrated in FIG. 23. The sleeve holder 4b meshes with a high tooth portion 2a of the first gear 2 first when a fork 5 receives an external force from an actuator (not illustrated) and moves in the direction toward the first gear 2 (upward and leftward on the page) in order to engage the rotary shaft 1 with the first gear 2. As a result, the sleeve holder 4b rotates integrally with the first gear 2, and thus the sleeve holder 4b and the sleeve 4a rotate relative to each other. Subsequently, the friction plate 4c, which is biased by the spring 4d, presses the sleeve 4a toward the sleeve holder 4b and the rotation of the sleeve 4a and the rotation of the sleeve holder 4b are synchronized as a result. The sleeve 4a meshes with a low tooth portion 2b of the first gear 2 by the fork 5 further moving toward the first gear 2. As a result, the rotary shaft 1 and the second gear 2 rotate integrally with each other.

In the power transmission device disclosed in JP 2017-150587A, the fork 5 that is given the external force by the actuator is required to move every component, including the sleeve 4a, the sleeve holder 4b, the friction plate 4c, the spring 4d, and the pressure member 4e constituting the mechanism, in moving the rotation absorption mechanism 4. As a result, it is desirable to reduce the weight of (the components that constitute) the rotation absorption mechanism 4 in order to further reduce the electric power consumption of the motor that drives the actuator.

The sleeve holder 4b and the pressure member 4e are indirectly attached to the rotary shaft 1 via the sleeve 4a without being directly attached to the rotary shaft 1. Accordingly, it is desirable that some device is applied in order to further reduce the shaft runout of each of the sleeve holder 4b and the pressure member 4e capable of resulting from the impact that is generated when the rotary shaft 1 is engaged with the first gear 2 or the second gear 3.

Thus, a need exists for a power transmission device which is not susceptible to the drawback mentioned above.

### SUMMARY

A power transmission device according to an aspect of this disclosure includes a first rotating member configured to be rotated by power transmitted from a prime mover, a second rotating member configured to rotate relative to the first rotating member, a first engagement member configured to rotate integrally with the second rotating member at all times, a second engagement member configured to be pressed toward the first engagement member, and a moving member configured to rotate integrally with the first rotating member at all times, be separated from the first engagement member and the second engagement member at an initial position, mesh with the second engagement member to cause the second engagement member to rotate integrally with the first rotating member at a first preparation position where the moving member has moved in an axial direction of the first rotating member from the initial position by receiving an external force, and cause the second rotating member to rotate integrally with the first rotating member by meshing with the first engagement member and causing the first engagement member to rotate integrally with the first rotating member at a first switching position where the moving member has moved in the axial direction of the first rotating member from the first preparation position by receiving an external force.

According to various embodiments, it is possible to provide a performance-improving power transmission device.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view schematically illustrating the configuration of a power transmission device according to an embodiment;

FIG. 2 is a front view schematically illustrating the configuration of an intermediate portion 114 of a rotary shaft 110 in a power transmission device 10 illustrated in FIG. 1;

FIG. 3 is a front view schematically illustrating the configuration of a first gear 120 in the power transmission device 10 illustrated in FIG. 1;

FIG. 4 is a front view schematically illustrating the configuration of a sleeve 140 in the power transmission device 10 illustrated in FIG. 1;

FIG. 5 is a front view schematically illustrating the configuration of first main engagement teeth 150 in the power transmission device 10 illustrated in FIG. 1;

FIG. 6 is a front view schematically illustrating the configuration of first pre-engagement teeth 160 in the power transmission device 10 illustrated in FIG. 1;

FIG. 7 is a front view schematically illustrating the configurations of a snap ring 171 and a leaf spring 172, which constitute a first pressure mechanism 170 in the power transmission device 10 illustrated in FIG. 1;

FIG. 8 is a front view schematically illustrating the configuration of a pressure member 173, which constitutes the first pressure mechanism 170 in the power transmission device 10 illustrated in FIG. 1;

FIG. 9 is an enlarged cross-sectional view schematically illustrating the configuration of a part of the power transmission device 10 illustrated in FIG. 1 and illustrating the configuration of the part as viewed from a surface cut at the tooth bottom of external teeth 132b formed on an outer peripheral surface 132a of a small-diameter portion 132 of a second gear 130;

FIG. 10 is an enlarged cross-sectional view schematically illustrating the configuration of the part of the power transmission device 10 illustrated in FIG. 1 and illustrating the configuration of the part as viewed from a surface cut at the tooth tip of the external teeth 132b formed on the outer peripheral surface 132a of the small-diameter portion 132 of the second gear 130;

FIG. 11 is a diagram illustrating a state where the sleeve 140 in the power transmission device 10 illustrated in FIG. 1 is at a first preparation position P₁₁ where the sleeve 140 meshes with the first pre-engagement teeth 160;

FIG. 12 is a diagram illustrating a state where the sleeve 140 in the power transmission device 10 illustrated in FIG. 1 is at a first switching position P₁₂ where the sleeve 140 meshes with the first main engagement teeth 150;

FIG. 13 is a cross-sectional view illustrating the flow of lubricating oil in the power transmission device 10 illustrated in FIG. 1;

FIG. 14 is a schematic diagram illustrating an example of a configuration controlling the sleeve 140 and the rotary shaft 110 in the power transmission device 10 illustrated in FIG. 1;

FIG. 15 is a schematic diagram illustrating another example of the configuration controlling the sleeve 140 and the rotary shaft 110 in the power transmission device 10 illustrated in FIG. 1;

FIG. 16 is a flow diagram illustrating a method for performing vehicle speed change control by using the power transmission device 10 illustrated in FIG. 1;

FIG. 17 is a diagram schematically illustrating how various vehicle elements change in accordance with the flow diagram illustrated in FIG. 16;

FIG. 18 is a block diagram schematically illustrating an example of a configuration that can be mounted and used in the power transmission device 10 described with reference to the drawings including FIG. 1 so that the function of estimating the drag torque of a motor and correcting the torque of the motor is realized;

FIG. 19 is a flow diagram illustrating an example of processing executed by the power transmission device 10 illustrated in FIG. 18;

FIG. 20 is a flow diagram illustrating an example of the processing executed by the power transmission device 10 illustrated in FIG. 18;

FIG. 21 is a timing diagram schematically illustrating an example of the processing executed by the power transmission device 10 illustrated in FIG. 18;

FIG. 22 is a diagram in which the timing diagram illustrated in FIG. 21 is enlarged in part; and

FIG. 23 is a cross-sectional view illustrating the configuration of a power transmission device according to the related art.

### DETAILED DESCRIPTION

Hereinafter, various embodiments disclosed here will be described with reference to the accompanying drawings. Constituent elements common to the drawings are denoted by the same reference numerals. It should be noted that a constituent element expressed in one drawing is omitted in another for convenience of description and the drawings may not be accurate in terms of scale.

### 1. Overall Configuration of Power Transmission Device

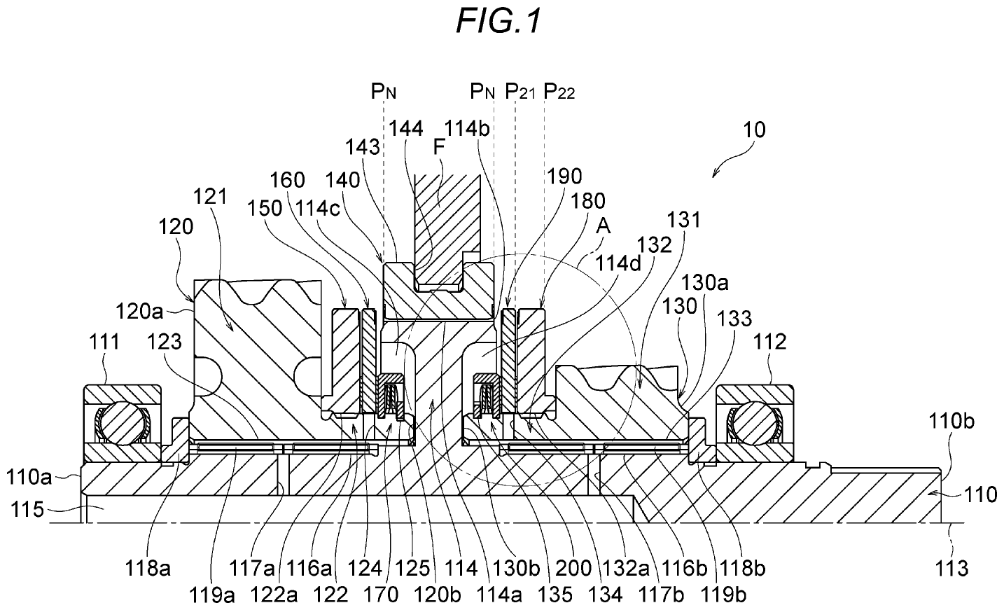

FIG. 1 is a cross-sectional view schematically illustrating the configuration of a power transmission device according to an embodiment. As illustrated in FIG. 1, mainly a rotary shaft (first rotating member) 110, a first gear (second rotating member) 120, a second gear (third rotating member) 130, and a sleeve (moving member) 140 can be included in a power transmission device 10 according to an embodiment. The rotary shaft 110 is rotated by power transmitted from a prime mover. The first gear 120 rotates relative to the rotary shaft 110 with the rotary shaft 110 inserted through the first gear 120 (the rotary shaft 110 is inserted through the first gear 120). The second gear 130 rotates relative to the rotary shaft 110 with the rotary shaft 110 inserted through the second gear 130 (the rotary shaft 110 is inserted through the second gear 130). The sleeve 140 integrally rotates at all times with the rotary shaft 110 inserted through the sleeve 140 by meshing with the rotary shaft 110.

Further, the power transmission device 10 is capable of including first main engagement teeth (first engagement member) 150, first pre-engagement teeth (second engagement member) 160, and a first pressure mechanism 170 as constituent elements related to the first gear 120. The first main engagement teeth 150 integrally rotate at all times with the first gear 120 inserted through the first main engagement teeth 150 by meshing with the first gear 120 (the first gear 120 is inserted through the first main engagement teeth 150). The first pre-engagement teeth 160 are capable of rotating relative to the first gear 120 in a state where the first gear 120 is inserted through the first pre-engagement teeth 160 and no external force is received (the first gear 120 is inserted through the first pre-engagement teeth 160). The first pressure mechanism 170 presses the first pre-engagement teeth 160 toward the first main engagement teeth 150.

Furthermore, the power transmission device 10 is capable of including second main engagement teeth (third engagement member) 180, second pre-engagement teeth (fourth engagement member) 190, and a second pressure mechanism 200 as constituent elements related to the second gear 130. The second main engagement teeth 180 integrally rotate at all times with the second gear 130 inserted through the second main engagement teeth 180 by meshing with the second gear 130 (the second gear 130 is inserted through the second main engagement teeth 180). The second pre-engagement teeth 190 are capable of rotating relative to the second gear 130 in a state where the second gear 130 is inserted through the second pre-engagement teeth 190 and no external force is received (the second gear 130 is inserted through the second pre-engagement teeth 190). The second pressure mechanism 200 presses the second pre-engagement teeth 190 toward the second main engagement teeth 180.

### 1-1. Rotary Shaft (First Rotating Member) 110

The rotary shaft 110 is capable of rotating by means of the power transmitted from the prime mover. Here, as an example, the rotary shaft 110 is capable of rotating by means of power transmitted from a motor as the prime mover.

The rotary shaft 110 is capable of having, for example, a substantially cylindrical shape as a whole. The rotary shaft 110 is rotatably supported by a first bearing 111 in the vicinity of one end 110a of the rotary shaft 110 and is rotatably supported by a second bearing 112 in the vicinity of the other end 110b of the rotary shaft 110. As a result, the rotary shaft 110 is capable of rotating around a central axis 113 of the rotary shaft 110.

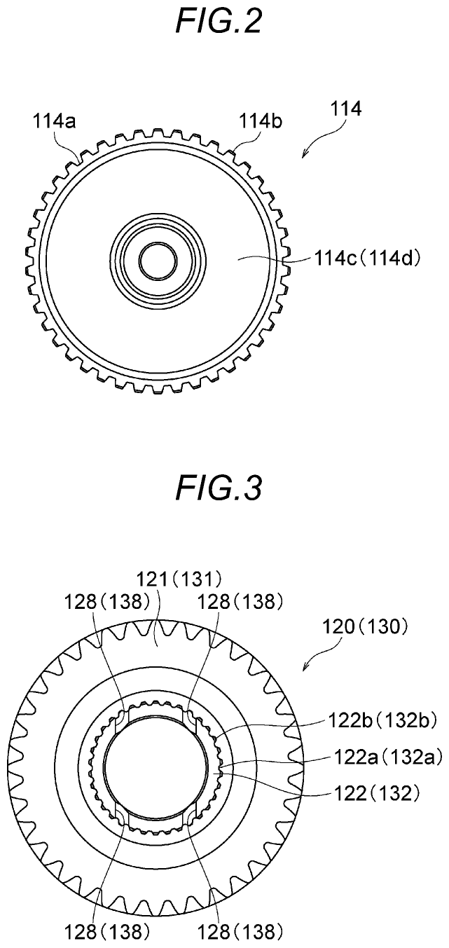

The rotary shaft 110 is capable of having an intermediate portion (hub) 114 having a substantially cylindrical shape at a position between the one end 110a and the other end 110b of the rotary shaft 110. FIG. 2 is a front view schematically illustrating the configuration of the intermediate portion 114 of the rotary shaft 110 in the power transmission device 10 illustrated in FIG. 1.

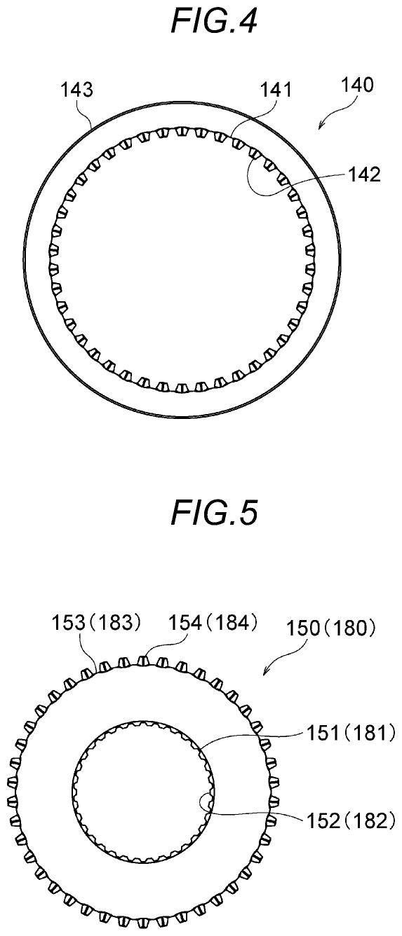

Referring to FIGS. 1 and 2, the intermediate portion 114 is larger in diameter than the one end 110a and the other end 110b. The intermediate portion 114 is capable of having external teeth 114b on a first outer peripheral surface 114a of the intermediate portion 114. The external teeth 114b are spline-coupled to internal teeth 142 (described later with reference to FIG. 4), which are formed on an inner peripheral surface 141 of the sleeve 140.

The intermediate portion 114 is capable of having an annularly extending first recessed portion 114c in order to receive a part of the first gear 120 on the one end 110a side. The intermediate portion 114 is capable of having an annularly extending second recessed portion 114d in order to receive a part of the second gear 130 on the other end 110b side.

The rotary shaft 110 is capable of having an inner region 115 in the rotary shaft 110. The inner region 115 extends along the central axis 113 and accommodates lubricating oil. The rotary shaft 110 is capable of having a first communication bore 117a, which allows the inner region 115 and a second outer peripheral surface 116a to communicate with each other. The second outer peripheral surface 116a faces an inner peripheral surface 123 of the first gear 120. Further, the rotary shaft 110 is capable of having a third communication bore 117b, which allows the inner region 115 and a third outer peripheral surface 116b to communicate with each other. The third outer peripheral surface 116b faces an inner peripheral surface 133 of the second gear 130.

The rotary shaft 110 is capable of having an annularly extending first locking member 118a in order to sandwich and fix the first gear 120 between the rotary shaft 110 and the first recessed portion 114c of the intermediate portion 114. In addition, the rotary shaft 110 is capable of having an annularly extending second locking member 118b in order to sandwich and fix the second gear 130 between the rotary shaft 110 and the second recessed portion 114d of the intermediate portion 114.

The rotary shaft 110 is capable of having a third bearing (needle bearing) 119a on the second outer peripheral surface 116a, which faces the inner peripheral surface 123 of the first gear 120. The third bearing 119a facilitates the relative rotation of the first gear 120 and the rotary shaft 110. In addition, the rotary shaft 110 is capable of having a fourth bearing (needle bearing) 119b on the third outer peripheral surface 116b, which faces the inner peripheral surface 133 of the second gear 130. The fourth bearing 119b facilitates the relative rotation of the second gear 130 and the rotary shaft 110.

### 1-2. First Gear (Second Rotating Member) 120

FIG. 3 is a front view schematically illustrating the configuration of the first gear 120 in the power transmission device 10 illustrated in FIG. 1.

Referring to FIGS. 1 and 3, the first gear 120 extends from one end 120a to the other end 120b and is capable of including a substantially cylindrical large-diameter portion 121 and a substantially cylindrical small-diameter portion 122, which is continuously connected to the large-diameter portion 121 and is smaller in outer diameter than the large-diameter portion 121. The one end 120a of the first gear 120 is locked by the first locking member 118a. The other end 120b of the first gear 120 intrudes into the first recessed portion 114c of the rotary shaft 110 and is locked by the side wall that surrounds the first recessed portion 114c of the rotary shaft 110.

The flush inner peripheral surface 123 is formed by the inner peripheral surface of the large-diameter portion 121 of the first gear 120 and the inner peripheral surface of the small-diameter portion 122 cooperating with each other. The inner peripheral surface 123 of the first gear 120 abuts against the third bearing 119a, which is formed on the second outer peripheral surface 116a of the rotary shaft 110. As a result, the first gear 120 is capable of easily rotating relative to the rotary shaft 110.

External teeth 122b for spline coupling to the first main engagement teeth 150 or the like are formed on an outer peripheral surface 122a of the small-diameter portion 122.

The first gear 120 is capable of having a second communication bore 124, which allows the inner peripheral surface 123 of the first gear 120 and the outer peripheral surface 122a of the small-diameter portion 122 to communicate with each other. Preferably, the second communication bore 124 can be formed at a position facing the first pre-engagement teeth 160. The first gear 120 is capable of having at least one second communication bore 124.

In addition, as illustrated in FIG. 3, four grooves 128 as an example can be formed in the end surface of the small-diameter portion 122 (end surface facing the intermediate portion 114) so that the lubricating oil passes. The groove 128 allows the lubricating oil to be supplied between the relatively rotating small-diameter portion 122 and intermediate portion 114.

### 1-3. Sleeve (Moving Member) 140

FIG. 4 is a front view schematically illustrating the configuration of the sleeve 140 in the power transmission device 10 illustrated in FIG. 1. Referring to FIGS. 1 and 4, the sleeve 140 has a substantially annular shape as a whole.

The sleeve 140 has the internal teeth 142 on the inner peripheral surface 141 of the sleeve 140. The internal teeth 142 mesh with the external teeth 114b, which are formed on the outer peripheral surface 114a of the intermediate portion 114 of the rotary shaft 110. The sleeve 140 is capable of integrally rotating at all times with the intermediate portion 114 of the rotary shaft 110 inserted through the sleeve 140 by meshing with the intermediate portion 114 (the intermediate portion 114 is inserted through the sleeve 140).

The sleeve 140 has a recessed portion 144, which extends in a substantially annular shape, in an outer peripheral surface 143 of the sleeve 140. The sleeve 140 accommodates the distal end portion of a shift fork F, which is controlled by an actuator (not illustrated), in the recessed portion 144. As a result, the sleeve 140 is capable of moving in the direction of the central axis 113 of the rotary shaft 110 while maintaining meshing with the intermediate portion 114 of the rotary shaft 110 (while rotating integrally with the rotary shaft 110) as the shift fork F moves in the direction of the central axis 113 of the rotary shaft 110.

### 1-4. First Main Engagement Teeth 150 (First Engagement Member)

FIG. 5 is a front view schematically illustrating the configuration of the first main engagement teeth 150 in the power transmission device 10 illustrated in FIG. 1. Referring to FIGS. 1 and 5, the main engagement teeth 150 have a substantially annular shape as a whole.

The first main engagement teeth 150 have internal teeth 152 for spline coupling to the external teeth 122b on an inner peripheral surface 151 of the first main engagement teeth 150. The external teeth 122b are formed on the outer peripheral surface 122a of the small-diameter portion 122 of the first gear 120. As a result, the first main engagement teeth 150 are spline-coupled to (mesh with) the first gear 120 by the small-diameter portion 122 of the first gear 120 being inserted through the first main engagement teeth 150 and are capable of rotating integrally with the first gear 120 at all times. In another embodiment, the first main engagement teeth 150 may rotate integrally with the first gear 120 at all times by being formed integrally with the first gear 120.

The first main engagement teeth 150 have external teeth 154 on an outer peripheral surface 153 of the first main engagement teeth 150. The external teeth 154 mesh with the internal teeth 142, which are formed on the inner peripheral surface 141 of the sleeve 140. As a result, the first main engagement teeth 150 are capable of rotating integrally with the sleeve 140 through spline coupling to (meshing with) the sleeve 140 that has moved toward the first main engagement teeth 150 along the central axis 113 of the rotary shaft 110.

### 1-5. First Pre-Engagement Teeth 160 (Second Engagement Member)

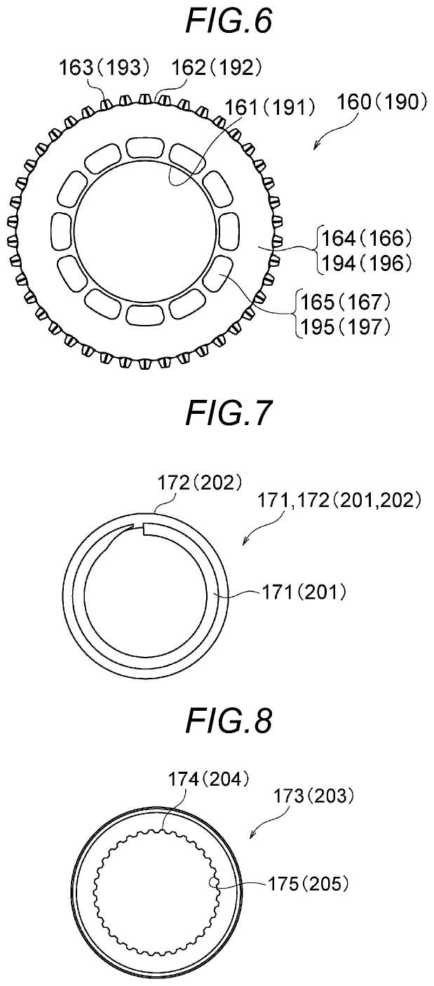

FIG. 6 is a front view schematically illustrating the configuration of the first pre-engagement teeth 160 in the power transmission device 10 illustrated in FIG. 1. Referring to FIGS. 1 and 6, the first pre-engagement teeth 160 have a substantially annular shape as a whole. In addition, the first pre-engagement teeth 160 have the same outer diameter as the first main engagement teeth 150 described above.

The first pre-engagement teeth 160 have a substantially annular inner peripheral surface 161 having no internal teeth. The inner diameter of the inner peripheral surface 161 is larger than the outer diameter of the small-diameter portion 122 of the first gear 120. As a result, the first pre-engagement teeth 160 are capable of rotating relative to the first gear 120 (in a state where no external force is received) by the small-diameter portion 122 of the first gear 120 being inserted through the first pre-engagement teeth 160.

The first pre-engagement teeth 160 have external teeth 163 on an outer peripheral surface 162 of the first pre-engagement teeth 160. The external teeth 163 mesh with the internal teeth 142 formed on the inner peripheral surface 141 of the sleeve 140. As a result, the first pre-engagement teeth 160 are capable of rotating integrally with the sleeve 140 through spline coupling to (meshing with) the sleeve 140 that has moved toward the first pre-engagement teeth 160 along the central axis 113 of the rotary shaft 110.

The first pre-engagement teeth 160 have a plurality of friction plates 165 on a surface 164 facing the first main engagement teeth 150. The friction plates 165 are attached at intervals in a circumferential direction. In addition, the first pre-engagement teeth 160 have a plurality of friction plates 167 on a surface 166 facing the first pressure mechanism 170. The friction plates 167 are attached at intervals in the circumferential direction. As a result, in a state where the first pre-engagement teeth 160 do not mesh with the sleeve 140, the first pre-engagement teeth 160 are capable of rotating integrally with the first main engagement teeth 150 by being pressed toward the first main engagement teeth 150 from the first pressure mechanism 170.

### 1-6. First Pressure Mechanism 170

FIG. 7 is a front view schematically illustrating the configurations of a snap ring 171 and a leaf spring 172, which constitute the first pressure mechanism 170 in the power transmission device 10 illustrated in FIG. 1. FIG. 8 is a front view schematically illustrating the configuration of a pressure member 173, which constitutes the first pressure mechanism 170 in the power transmission device 10 illustrated in FIG. 1.

Referring to FIGS. 1 and 7, the snap ring 171 has a substantially annular shape as a whole. By the small-diameter portion 122 of the first gear 120 being inserted through the snap ring 171, the snap ring 171 is locked (fixed) to a groove portion 125, which is formed in the outer peripheral surface 122a of the small-diameter portion 122 and extends in a substantially annular shape. As a result, the snap ring 171 rotates integrally with the first gear 120.

The leaf spring 172 extends in a substantially annular shape as a whole. The leaf spring 172 is disposed adjacent to the snap ring 171 with the small-diameter portion 122 of the first gear 120 inserted through the leaf spring 172.

Referring to FIGS. 1 and 8, the pressure member 173 has a substantially annular shape as a whole. The pressure member 173 has internal teeth 175 for spline coupling to the external teeth 122b on an inner peripheral surface 174 of the pressure member 173. The external teeth 122b are formed on the outer peripheral surface 122a of the small-diameter portion 122 of the first gear 120. As a result, the pressure member 173 is spline-coupled to (meshes with) the first gear 120 by the small-diameter portion 122 of the first gear 120 being inserted through the pressure member 173 and is capable of rotating integrally with the first gear 120. Although the pressure member 173 is spline-coupled to the first gear 120, the pressure member 173 is in a state of being capable of moving along the central axis 113 of the rotary shaft 110.

The pressure member 173 is disposed with the leaf spring 172 sandwiched between the snap ring 171 and the pressure member 173. The pressure member 173 abuts against the first pre-engagement teeth 160 on the plurality of friction plates 167 attached to the surface 166 of the first pre-engagement teeth 160. The pressure member 173 presses the first pre-engagement teeth 160 toward the first main engagement teeth 150 and the large-diameter portion 121 of the first gear 120 by being biased by the leaf spring 172. Although FIG. 1 illustrates an example in which the pressure member 173 has a substantially L-shaped cross-sectional shape so as to restrict an outer diameter-direction movement of the leaf spring 172, the pressure member 173 may have a substantially I-shaped cross-sectional shape in another embodiment.

It can be said that the above-described first pre-engagement teeth 160, first main engagement teeth 150, and first pressure mechanism 170 as a whole form a first rotation absorption mechanism functioning as a mechanism absorbing the difference between the rotation of the rotary shaft 110 and the rotation of the first gear 120.

### 1-7. Second Gear 130 (Third Rotating Member)

The second gear 130 has substantially the same configuration as the above-described first gear 120 except that the size of the large-diameter portion of the second gear 130 is different. Accordingly, the second gear 130 will be described below with reference signs that correspond to the second gear 130 given in the parentheses in FIG. 3, which illustrates the configuration of the first gear 120.

Referring to FIGS. 1 and 3, the second gear 130 extends from one end 130a to the other end 130b and is capable of including a substantially cylindrical large-diameter portion 131 and a substantially cylindrical small-diameter portion 132, which is continuously connected to the large-diameter portion 131 and is smaller in outer diameter than the large-diameter portion 131. The size of the small-diameter portion 132 can be the same as the size of the small-diameter portion 122 of the first gear 120. In addition, the size of the large-diameter portion 131 can be the same as the size of the large-diameter portion 121 of the first gear 120 except that the outer diameter of the large-diameter portion 131 is smaller than the outer diameter of the large-diameter portion 121 of the first gear 120. The second gear 130 is disposed such that the other end 130b of the second gear 130 (or the small-diameter portion 132 of the second gear 130) faces the other end 120b of the first gear 120 (or the small-diameter portion 122 of the first gear 120).

The one end 130a of the second gear 130 is locked by the second locking member 118b. The other end 130b of the second gear 130 intrudes into the second recessed portion 114d of the rotary shaft 110 and is locked by the side wall that surrounds the second recessed portion 114d of the rotary shaft 110.

The flush inner peripheral surface 133 is formed by the inner peripheral surface of the large-diameter portion 131 of the second gear 130 and the inner peripheral surface of the small-diameter portion 132 cooperating with each other. The inner peripheral surface 133 of the second gear 130 abuts against the fourth bearing 119b, which is formed on the third outer peripheral surface 116b of the rotary shaft 110. As a result, the second gear 130 is capable of easily rotating relative to the rotary shaft 110.

External teeth 132b for spline coupling to the second main engagement teeth 180 or the like are formed on an outer peripheral surface 132a of the small-diameter portion 132.

The second gear 130 is capable of having a fourth communication bore 134, which allows the inner peripheral surface 133 of the second gear 130 and the outer peripheral surface 132a of the small-diameter portion 132 to communicate with each other. Preferably, the fourth communication bore 134 can be formed at a position facing the second pre-engagement teeth 190. The second gear 130 is capable of having at least one fourth communication bore 134.

As illustrated in FIG. 3, four grooves 138 as an example can be formed in the end surface of the small-diameter portion 132 (end surface facing the intermediate portion 114) so that the lubricating oil passes. The groove 138 allows the lubricating oil to be supplied between the relatively rotating small-diameter portion 132 and intermediate portion 114.

### 1-8. Second Main Engagement Teeth 180 (Third Engagement Member)

The second main engagement teeth 180 are capable of having the same shape as the first main engagement teeth 150 described above. Accordingly, the configuration of the second main engagement teeth 180 will be described with reference to FIGS. 5 and 1. Reference signs corresponding to the second main engagement teeth 180 are described in the parentheses in FIG. 5.

The second main engagement teeth 180 have internal teeth 182 for spline coupling to the external teeth 132b on the inner peripheral surface 151 (181) of the second main engagement teeth 180. The external teeth 132b are formed on the outer peripheral surface 132a of the small-diameter portion 132 of the second gear 130. As a result, the second main engagement teeth 180 are spline-coupled to (mesh with) the second gear 130 by the small-diameter portion 132 of the second gear 130 being inserted through the second main engagement teeth 180 and are capable of rotating integrally with the second gear 130 at all times. In another embodiment, the second main engagement teeth 180 may rotate integrally with the second gear 130 at all times by being formed integrally with the second gear 130.

The second main engagement teeth 180 have external teeth 184 on an outer peripheral surface 183 of the second main engagement teeth 180. The external teeth 184 mesh with the internal teeth 142, which are formed on the inner peripheral surface 141 of the sleeve 140. As a result, the second main engagement teeth 180 are capable of rotating integrally with the sleeve 140 through spline coupling to (meshing with) the sleeve 140 that has moved toward the first main engagement teeth 150 along the central axis 113 of the rotary shaft 110.

Although the second main engagement teeth 180 are capable of having the same shape as the first main engagement teeth 150, the first main engagement teeth 150 and the second main engagement teeth 180 in this case can be disposed with the same surfaces (front surfaces or back surfaces) facing each other.

### 1-9. Second Pre-Engagement Teeth 190 (Fourth Engagement Member)

The second pre-engagement teeth 190 are capable of having the same shape as the first pre-engagement teeth 160 described above. Accordingly, the configuration of the second pre-engagement teeth 190 will be described with reference to FIGS. 6 and 1. In the parentheses in FIG. 6, reference signs corresponding to the second pre-engagement teeth 190 are described or reference signs corresponding to the second pre-engagement teeth 190 and reference signs corresponding to the first pre-engagement teeth 160 are described together.

The second pre-engagement teeth 190 have a substantially annular inner peripheral surface 191 having no internal teeth. The inner diameter of the inner peripheral surface 191 is larger than the outer diameter of the small-diameter portion 132 of the second gear 130. As a result, the second pre-engagement teeth 190 are capable of rotating relative to the second gear 130 (in a state where no external force is received) by the small-diameter portion 132 of the second gear 130 being inserted through the second pre-engagement teeth 190. The second pre-engagement teeth 190 have the same outer diameter as the second main engagement teeth 180 described above.

The second pre-engagement teeth 190 have external teeth 193 on an outer peripheral surface 192 of the second pre-engagement teeth 190. The external teeth 193 mesh with the internal teeth 142, which are formed on the inner peripheral surface 141 of the sleeve 140. As a result, the second pre-engagement teeth 190 are capable of rotating integrally with the sleeve 140 through spline coupling to (meshing with) the sleeve 140 that has moved toward the second pre-engagement teeth 190 along the central axis 113 of the rotary shaft 110.

The second pre-engagement teeth 190 have a plurality of friction plates 195 on a surface 194 facing the second main engagement teeth 180. The friction plates 195 are attached at intervals in the circumferential direction. In addition, the second pre-engagement teeth 190 have a plurality of friction plates 197 on a surface 196 facing the second pressure mechanism 200. The friction plates 197 are attached at intervals in the circumferential direction. As a result, in a state where the second pre-engagement teeth 190 do not mesh with the sleeve 140, the second pre-engagement teeth 190 are capable of rotating integrally with the second main engagement teeth 180 by being pressed toward the second main engagement teeth 180 from the second pressure mechanism 200.

Although the second pre-engagement teeth 190 are capable of having the same shape as the first pre-engagement teeth 160, the first pre-engagement teeth 160 and the second pre-engagement teeth 190 in this case can be disposed with the same surfaces (front surfaces or back surfaces) facing each other.

### 1-10. Second Pressure Mechanism 200

The second pressure mechanism 200 is capable of having the same shape as the first pressure mechanism 170 described above. Accordingly, the configuration of the second pressure mechanism 200 will be described with reference to FIGS. 7, 8, and 1. Reference signs corresponding to the second pressure mechanism 200 are described in the parentheses in FIGS. 7 and 8.

Referring to FIGS. 1 and 7, a snap ring 201 has a substantially annular shape as a whole. By the small-diameter portion 132 of the second gear 130 being inserted through the snap ring 201, the snap ring 201 is locked (fixed) to a groove portion 135, which is formed in the outer peripheral surface 132a of the small-diameter portion 132 and extends in a substantially annular shape. As a result, the snap ring 201 rotates integrally with the second gear 130.

A leaf spring 202 extends in a substantially annular shape as a whole. The leaf spring 202 is disposed adjacent to the snap ring 201 with the small-diameter portion 132 of the second gear 130 inserted through the leaf spring 202.

Referring to FIGS. 1 and 8, a pressure member 203 has a substantially annular shape as a whole. The pressure member 203 has internal teeth 205 for spline coupling to the external teeth 132b on an inner peripheral surface 204 of the pressure member 203. The external teeth 132b are formed on the outer peripheral surface 132a of the small-diameter portion 132 of the second gear 130. As a result, the pressure member 203 is spline-coupled to (meshes with) the second gear 130 by the small-diameter portion 132 of the second gear 130 being inserted through the pressure member 203 and is capable of rotating integrally with the second gear 130 at all times. Although the pressure member 203 is spline-coupled to the second gear 130, the pressure member 203 is in a state of being capable of moving along the central axis 113 of the rotary shaft 110.

The pressure member 203 is disposed with the leaf spring 202 sandwiched between the snap ring 201 and the pressure member 203. The pressure member 203 abuts against the second pre-engagement teeth 190 on the plurality of friction plates 197 attached to the surface 196 of the second pre-engagement teeth 190. The pressure member 203 presses the second pre-engagement teeth 190 toward the second main engagement teeth 180 and the large-diameter portion 131 of the second gear 130 by being biased by the leaf spring 202. Although FIG. 1 illustrates an example in which the pressure member 203 has a substantially L-shaped cross-sectional shape so as to restrict an outer diameter-direction movement of the leaf spring 202, the pressure member 203 may have a substantially I-shaped cross-sectional shape in another embodiment.

Although the second pressure mechanism 200 is capable of having the same shape as the first pressure mechanism 170, each constituent element included in the first pressure mechanism 170 (the snap ring 171, the leaf spring 172, and the pressure member 173) and each constituent element included in the second pressure mechanism 200 (the snap ring 201, the leaf spring 202, and the pressure member 203) can be disposed with the same surfaces (front surfaces or back surfaces) facing each other in this case.

It can be said that the above-described second pre-engagement teeth 190, second main engagement teeth 180, and second pressure mechanism 200 as a whole form a second rotation absorption mechanism functioning as a mechanism absorbing the difference between the rotation of the rotary shaft 110 and the rotation of the second gear 130.

### 1-11. Relationship Between Second Gear 130 and Second Pre-Engagement Teeth 190, Second Main Engagement Teeth 180, and Pressure Mechanism 200

Next, the relationship between the second gear 130 and the second pre-engagement teeth 190, the second main engagement teeth 180, and the second pressure mechanism 200 will be described.

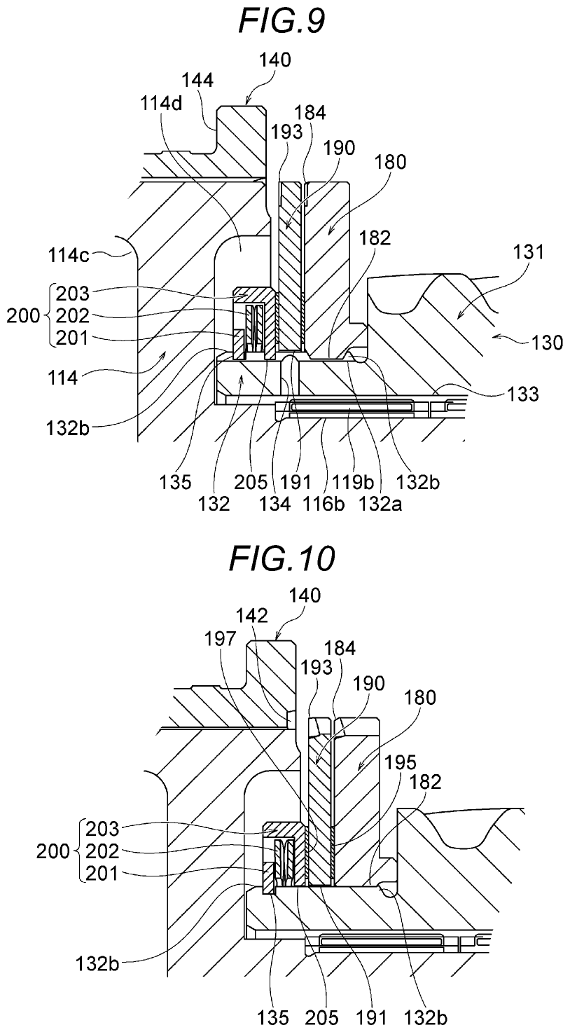

FIG. 9 is an enlarged cross-sectional view schematically illustrating the configuration of a part (Portion A) of the power transmission device 10 illustrated in FIG. 1. In FIG. 9, the configuration of the part is viewed from a surface cut at the tooth bottom of the external teeth 132b formed on the outer peripheral surface 132a of the small-diameter portion 132 of the second gear 130. FIG. 10 is an enlarged cross-sectional view schematically illustrating the configuration of the part (Portion A) of the power transmission device 10 illustrated in FIG. 1. In FIG. 10, the configuration of the part is viewed from a surface cut at the tooth tip of the external teeth 132b formed on the outer peripheral surface 132a of the small-diameter portion 132 of the second gear 130.

It can be seen from comparison between FIGS. 9 and 10 that the internal teeth 182 of the second main engagement teeth 180 mesh with the external teeth 132b formed on the outer peripheral surface 132a of the small-diameter portion 132 of the second gear 130. As a result, the second main engagement teeth 180 are capable of rotating integrally with the second gear 130. It can be seen that the internal teeth 205 of the pressure member 203 in the second pressure mechanism 200 mesh with the external teeth 132b formed on the outer peripheral surface 132a of the small-diameter portion 132 of the second gear 130 as is the case with the internal teeth 182. As a result, the pressure member 203 as well as the second main engagement teeth 180 is capable of rotating integrally with the second gear 130.

It can be seen that the inner peripheral surface 191 of the second pre-engagement teeth 190 does not mesh with the external teeth 132b formed on the outer peripheral surface 132a of the small-diameter portion 132 of the second gear 130 and is disposed at a distance from the tooth tip of the external teeth 132b. The second pre-engagement teeth 190 are pressed in the direction toward the second main engagement teeth 180 from the pressure member 203 biased by the leaf spring 202. As a result, the second pre-engagement teeth 190 are capable of rotating integrally with the second main engagement teeth 180 (eventually the second gear 130) in a state where the external teeth 193 do not mesh with the internal teeth 142 of the sleeve 140 and are capable of rotating integrally with the sleeve 140 (eventually the rotary shaft 110) in a state where the external teeth 193 mesh with the internal teeth 142 of the sleeve 140.

As best illustrated in FIG. 9, the fourth communication bore 134 allows the inner peripheral surface 133 of the second gear 130 and the tooth bottom of the external teeth 132b formed on the outer peripheral surface 132a of the small-diameter portion 132 to communicate with each other. As a result, a centrifugal force allows the lubricating oil that has reached the fourth communication bore 134 to intrude between the second pre-engagement teeth 190 and the second main engagement teeth 180.

The above-described relationship between the second gear 130 and the second pre-engagement teeth 190, the second main engagement teeth 180, and the second pressure mechanism 200 applies similarly to the relationship with the first pre-engagement teeth 160, the first main engagement teeth 150, and the first pressure mechanism 170. The relationship with the first pre-engagement teeth 160, the first main engagement teeth 150, and the first pressure mechanism 170 is obtained by the “second pre-engagement teeth 190”, “second main engagement teeth 180”, “second pressure mechanism 200”, and “second gear 130” in the above description of “1-11” being replaced with “first pre-engagement teeth 160”, “first main engagement teeth 150”, “first pressure mechanism 170”, and “first gear 120”, respectively.

### 2. Action of Power Transmission Device 10

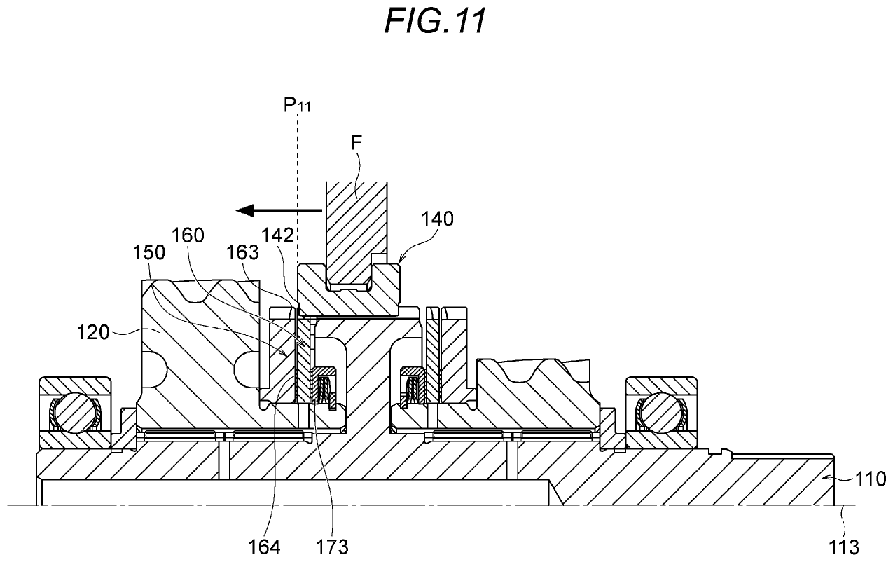

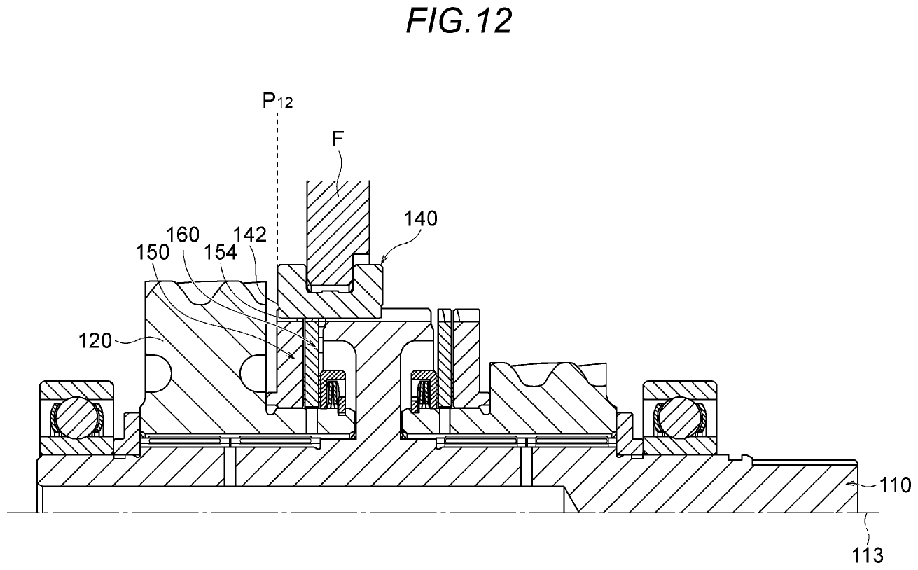

The action of the power transmission device 10 having the configuration described above will be described with reference to FIGS. 11 and 12 as well as FIG. 1 and so on. FIG. 11 is a diagram illustrating a state where the sleeve 140 in the power transmission device 10 illustrated in FIG. 1 is at a first preparation position P₁₁ where the sleeve 140 meshes with the first pre-engagement teeth 160. FIG. 12 is a diagram illustrating a state where the sleeve 140 in the power transmission device 10 illustrated in FIG. 1 is at a first switching position P₁₂ where the sleeve 140 meshes with the first main engagement teeth 150.

First, as illustrated in FIG. 1, the power transmission device 10 is in a neutral state in a state where the sleeve 140 is at “initial position P_{N}” and meshes only with the external teeth 114b of the intermediate portion 114 of the rotary shaft 110, that is, in a state where the sleeve 140 does not mesh with any of the first pre-engagement teeth 160, the first main engagement teeth 150, the second pre-engagement teeth 190, and the second main engagement teeth 180. In such a state, the power transmission device 10 transmits the power transmitted to the rotary shaft 110 neither to the first gear 120 nor to the second gear 130.

In this state, the rotary shaft 110 and the sleeve 140 rotate relative to the first gear 120, the first main engagement teeth 150, the first pre-engagement teeth 160, the second gear 130, the second main engagement teeth 180, and the second pre-engagement teeth 190. At this time, the first pre-engagement teeth 160 are pressed toward the first main engagement teeth 150 by the pressure member 173, and thus the first pre-engagement teeth 160 rotate integrally with the first main engagement teeth 150 (eventually the first gear 120).

Next, the sleeve 140 moves toward the first pre-engagement teeth 160 (upward and leftward on the page) in the direction of the central axis 113 of the rotary shaft 110 by being pressed by the shift fork F (receiving an external force). As illustrated in FIG. 11, the internal teeth 142 of the sleeve 140 mesh with the external teeth 163 of the first pre-engagement teeth 160 by the sleeve 140 moving to “first preparation position P₁₁” and the sleeve 140 causes the first pre-engagement teeth 160 to rotate integrally with the sleeve 140 as a result. In other words, the rotation of the sleeve 140 and the rotation of the first pre-engagement teeth 160 are synchronized.

Since the sleeve 140 and the rotary shaft 110 integrally rotate, the rotation of the sleeve 140 and the rotary shaft 110 and the rotation of the first pre-engagement teeth 160 are subsequently synchronized. The synchronization results in a rotational difference between the rotary shaft 110, the sleeve 140, and the first pre-engagement teeth 160 and the first main engagement teeth 150 and the first gear 120.

Further, the first pre-engagement teeth 160 rotate integrally with the first main engagement teeth 150 by the first pre-engagement teeth 160 pressed toward the first main engagement teeth 150 by the pressure member 173 pressing the first main engagement teeth 150 via the friction plate 164 (see FIG. 6). In other words, the rotation of the first pre-engagement teeth 160 and the rotation of the first main engagement teeth 150 are synchronized.

Subsequently, the sleeve 140 moves toward the first main engagement teeth 150 (upward and leftward on the page) in the direction of the central axis 113 of the rotary shaft 110 by being pressed by the shift fork F (receiving an external force). As illustrated in FIG. 12, the internal teeth 142 of the sleeve 140 mesh with the external teeth 154 of the first main engagement teeth 150 by the sleeve 140 moving to “first switching position P₁₂” and the sleeve 140 causes the first main engagement teeth 150 to rotate integrally with the sleeve 140 as a result. In other words, the rotation of the sleeve 140 and the rotation of the first main engagement teeth 150 are synchronized.

Since the sleeve 140 and the rotary shaft 110 integrally rotate, the rotation of the sleeve 140 and the rotary shaft 110 and the rotation of the first main engagement teeth 150 and the first gear 120 are subsequently synchronized. As a result, power is transmitted from the rotary shaft 110 to the first gear 120.

Described above is a case where the sleeve 140 moves from “initial position P_{N}” to “first switching position P₁₂” through “first preparation position P₁₁”, the sleeve 140 sequentially meshes with the first pre-engagement teeth 160 and the first main engagement teeth 150 as a result of the movement, and the sequential meshing results in power transmission from the rotary shaft 110 to the first gear 120 (a change in speed from neutral to gear stage “HI”). Also possible is a similar action being performed by the sleeve 140 moving from the “initial position P_{N}” illustrated in FIG. 1 to “second switching position P₂₂” through “second preparation position P₂₁”, the sleeve 140 sequentially meshing with the second pre-engagement teeth 190 and the second main engagement teeth 180 as a result, and the sequential meshing resulting in power transmission from the rotary shaft 110 to the second gear 130 (a change in speed from neutral to gear stage “LOW”).

### 3. Regarding Flow of Lubricating Oil in Power Transmission Device 10

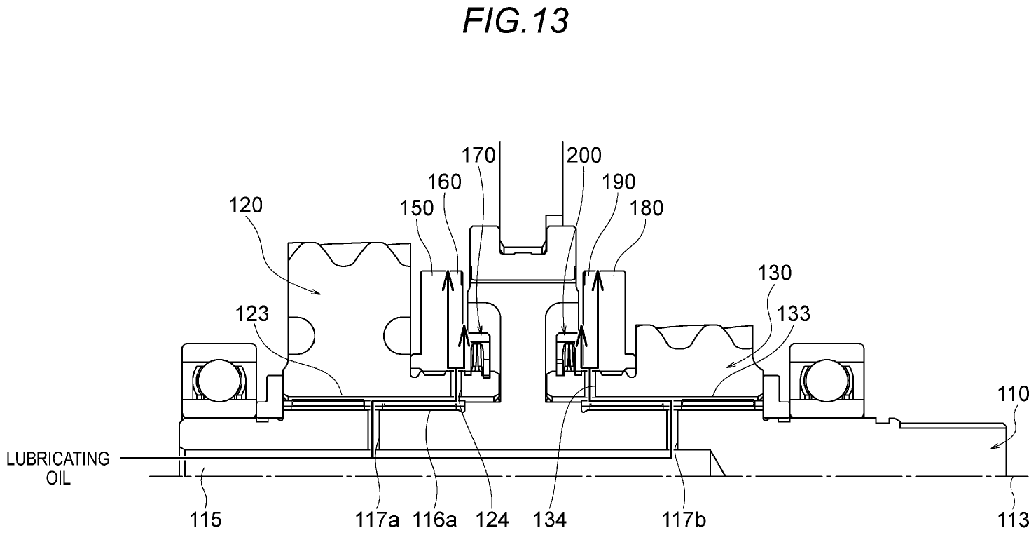

FIG. 13 is a cross-sectional view illustrating the flow of lubricating oil in the power transmission device 10 illustrated in FIG. 1. A centrifugal force is generated on the rotary shaft 110 by the rotary shaft 110 rotating around the central axis 113.

The lubricating oil accommodated in the inner region 115 of the rotary shaft 110 receives this centrifugal force, passes through the first communication bore 117a, and reaches the region between the second outer peripheral surface 116a of the rotary shaft 110 and the inner peripheral surface 123 of the first gear 120. Further, the lubricating oil that has reached this region is capable of receiving a centrifugal force, passing through the second communication bore 124, and intruding between the first main engagement teeth 150 and the first pre-engagement teeth 160 and between the first pre-engagement teeth 160 and the first pressure mechanism 170. Subsequently, the lubricating oil is capable of retreating to the outside from the spaces between the first main engagement teeth 150 and the first pre-engagement teeth 160 and between the first pre-engagement teeth 160 and the first pressure mechanism 170.

Likewise, the lubricating oil accommodated in the inner region 115 of the rotary shaft 110 receives a centrifugal force, passes through the third communication bore 117b, and reaches the region between the third outer peripheral surface 116b of the rotary shaft 110 and the inner peripheral surface 133 of the second gear 130. Further, the lubricating oil that has reached this region is capable of receiving a centrifugal force, passing through the fourth communication bore 134, and intruding between the second main engagement teeth 180 and the second pre-engagement teeth 190 and between the second pre-engagement teeth 190 and the second pressure mechanism 200. Subsequently, the lubricating oil is capable of retreating to the outside from the spaces between the second main engagement teeth 180 and the second pre-engagement teeth 190 and between the second pre-engagement teeth 190 and the second pressure mechanism 200.

### 4. Regarding Control of Sleeve 140 and Rotary Shaft 110

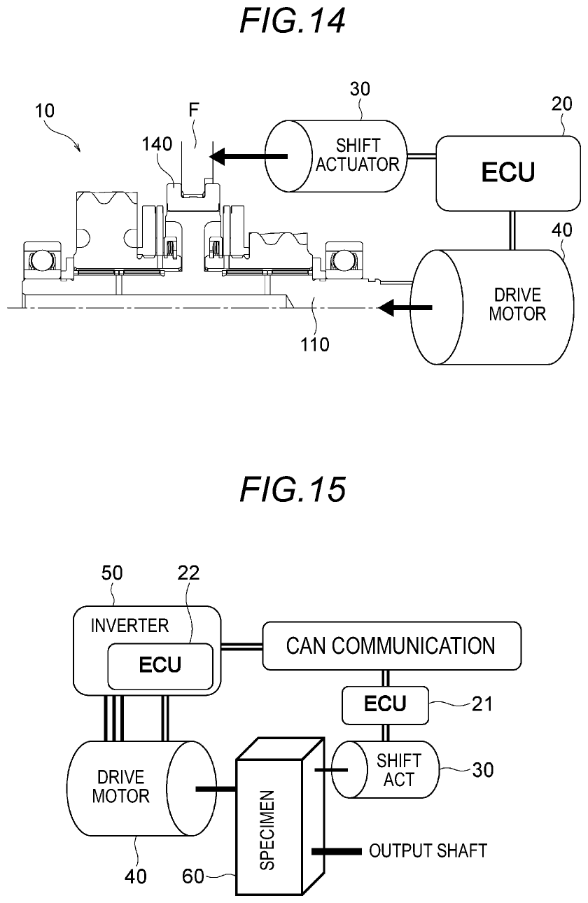

FIG. 14 is a schematic diagram illustrating an example of a configuration controlling the sleeve 140 and the rotary shaft 110 in the power transmission device 10 illustrated in FIG. 1. As illustrated in FIG. 14, an electronic control unit (ECU) 20 is capable of controlling the action of the shift fork F driven by a shift actuator 30 by controlling the shift actuator 30. As a result, the ECU 20 is capable of controlling the action of the sleeve 140 engaged with the shift fork F. In addition, the ECU 20 is capable of controlling the rotation of the rotary shaft 110 to which the power of a drive motor 40 is transmitted by controlling the drive motor 40.

FIG. 14 illustrates an example in which power is transmitted from the drive motor 40 to the rotary shaft 110. In a case where power is transmitted from an engine to the rotary shaft 110, the engine can be used in place of the drive motor 40 in FIG. 14.

FIG. 15 is a schematic diagram illustrating another example of the configuration controlling the sleeve 140 and the rotary shaft 110 in the power transmission device 10 illustrated in FIG. 1. As illustrated in FIG. 15, each of the shift actuator 30 and the drive motor 40 can be controlled by a unique ECU. In other words, it is possible to adopt a configuration in which a first ECU 21 controls the shift actuator 30 and a second ECU 22 and an inverter 50 control the drive motor 40. In this case, the first ECU 21 and the second ECU 22 can be controlled by controller area network (CAN) communication. The power transmission device 10 described above can be used as an example of a specimen 60 illustrated in FIG. 15.

### 5. Regarding Speed Change Control Using Power Transmission Device 10

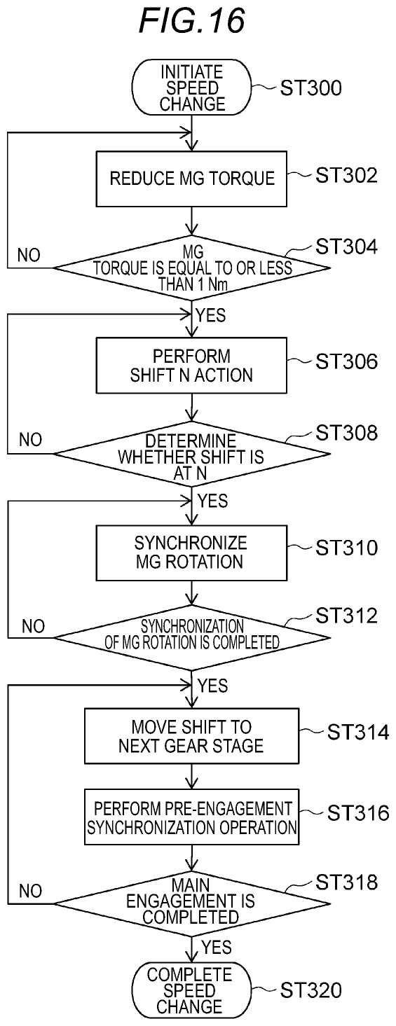

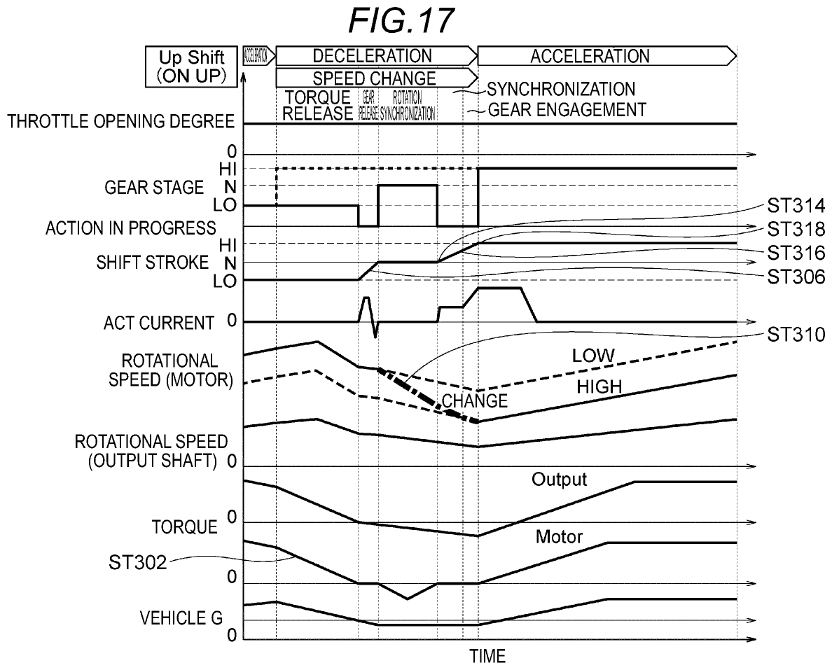

FIG. 16 is a flow diagram illustrating a method for performing vehicle speed change control by using the power transmission device 10 illustrated in FIG. 1. FIG. 17 is a diagram schematically illustrating how various vehicle elements change in accordance with the flow diagram illustrated in FIG. 16.

Described here as an example is a case where speed change is performed from gear stage “LOW” to gear stage “HI”.

First, the speed change control is initiated in step (hereinafter, referred to as “ST”) 300. Next, in ST302, the torque of the motor that supplies power to the rotary shaft 110 is reduced. As exemplified by reference sign “ST302” in FIG. 17, the torque of the motor decreases with time in this step. In a case where the rotary shaft 110 is driven not by the motor but by the engine, clutch release is performed in ST302.

In ST304, it is determined whether or not the torque of the motor has decreased to a predetermined value (“1 Nm” as an example here) or less. ST302 and ST304 described above are repeated in a case where it is determined that the torque of the motor is greater than the predetermined value. The processing proceeds to ST306 in a case where it is determined that the torque of the motor is equal to or less than the predetermined value. In a case where the rotary shaft 110 is driven not by the motor but by the engine, it is determined in ST304 whether or not the clutch release has been completed.

In ST306, a shift movement to neutral (state illustrated in FIG. 1) is performed. As exemplified by reference sign “ST306” in FIG. 17, a shift stroke movement is performed from “LOW” to “N” (neutral) in this step.

In ST308, it is determined whether or not the shift has completely moved to neutral. ST306 and ST308 described above are repeated in a case where it is determined that the shift has not completely moved to neutral. The processing proceeds to ST310 in a case where it is determined that the shift has completely moved to neutral.

In ST310, the rotational speed of the motor is synchronized to a rotational speed corresponding to “HI”. As exemplified by reference sign “ST310” in FIG. 17, the rotational speed of the motor approaches the rotational speed corresponding to “HI” from a rotational speed corresponding to “LOW” in this step.

In ST312, it is determined whether or not the rotational speed of the motor is synchronous with the rotational speed corresponding to “HI”. ST310 and ST312 described above are repeated in a case where it is determined that the rotational speed of the motor has yet to become synchronous with the rotational speed corresponding to “HI”. The processing proceeds to ST314 in a case where it is determined that the rotational speed of the motor is synchronous with the rotational speed corresponding to “HI”.

In ST314, a shift movement from neutral to “HI” is performed. As exemplified by reference sign “ST314” in FIG. 17, a shift stroke movement from neutral to “HI” is initiated in this step.

Pre-engagement (synchronization operation) is performed in ST316. In other words, meshing of the sleeve 140 with the first pre-engagement teeth 160 as described with reference to FIG. 11 is executed. The time of the synchronization is determined by the speed of movement of the shift actuator 30 (see FIGS. 14 and 15), and thus the action of the shift actuator 30 is controlled by the ECU 20 or the first ECU 21. As exemplified by reference sign “ST316” in FIG. 17, the shift stroke approaches “HI” with time in this step.

Main engagement is performed after the pre-engagement is completed. In other words, meshing of the sleeve 140 with the first main engagement teeth 150 as described with reference to FIG. 12 is executed.

In ST318, it is determined whether or not the main engagement has been completed. ST314, ST316, and ST318 described above are repeated in a case where it is determined that the main engagement has yet to be completed. The processing proceeds to ST320 in a case where it is determined that the main engagement has been completed (the state exemplified by reference sign “ST318” in FIG. 17 has been reached). The speed change from gear stage “LOW” to gear stage “HI” is completed in ST320.

Described above is a case where a change in speed is performed from gear stage “LOW” to gear stage “HI”. Similarly conceivable is a change in speed from gear stage “HI” to gear stage “LOW”. Needless to say, as for the change in speed from gear stage “HI” to gear stage “LOW”, FIG. 17 needs to be re-read as “gear stage” shifting from “HI” to “LOW” through neutral, “shift stroke” shifting from “HI” to “LOW” through neutral, and “rotational speed” changing from a rotational speed corresponding to “HI” to a rotational speed corresponding to “LOW”.

### 6. Modification Example

Described as the most preferable example in the embodiment described above is a case where both the first gear 120 (and the first pre-engagement teeth 160, the first main engagement teeth 150, and the first pressure mechanism 170 as constituent elements pertaining to the first gear 120) and the second gear 130 (and the second pre-engagement teeth 190, the second main engagement teeth 180, and the second pressure mechanism 200 as constituent elements pertaining to the second gear 130) are provided as illustrated in FIG. 1. However, the technical idea disclosed in the present application is also applicable in a case where at least one of the first gear 120 (and the constituent elements pertaining to the first gear 120) and the second gear 130 (and the constituent elements pertaining to the second gear 130) is provided.

Described as the most preferable example in the embodiment described above is a case where the first pre-engagement teeth 160 have the same shape as the second pre-engagement teeth 190, the first main engagement teeth 150 have the same shape as the second main engagement teeth 180, and the first pressure mechanism 170 has the same shape as the second pressure mechanism 200. However, the technical idea disclosed in the present application is also applicable in a case where the shapes of the first pre-engagement teeth 160 and the second pre-engagement teeth 190 differ from each other, the shapes of the first main engagement teeth 150 and the second main engagement teeth 180 differ from each other, and/or the shapes of the first pressure mechanism 170 and the second pressure mechanism 200 differ from each other.

Described in the embodiment described above is a case where the first gear 120 is provided with the first main engagement teeth 150, the first pre-engagement teeth 160, and the first pressure mechanism 170 and the rotary shaft 110 is provided with the sleeve 140. In another embodiment, the first gear 120 may be provided with the sleeve 140 and the rotary shaft 110 may be provided with the first main engagement teeth 150, the first pre-engagement teeth 160, and the first pressure mechanism 170. Likewise, the second gear 130 may be provided with the sleeve 140 and the rotary shaft 110 may be provided with the second main engagement teeth 180, the second pre-engagement teeth 190, and the second pressure mechanism 200.

Described in the embodiment described above is a case where the first main engagement teeth 150, the first pre-engagement teeth 160, and the first pressure mechanism 170 are disposed on the radially outer side of the small-diameter portion 122 of the first gear 120 and the first main engagement teeth 150 and the first pre-engagement teeth 160 are engaged with the sleeve 140 on the radially outer side. In another embodiment, the small-diameter portion 122 may extend radially outward of the first main engagement teeth 150, the first pre-engagement teeth 160, and the first pressure mechanism 170 and the first main engagement teeth 150 and the first pre-engagement teeth 160 may be engaged with the sleeve 140 on the radially inner side. Likewise, the small-diameter portion 132 may extend radially outward of the second main engagement teeth 180, the second pre-engagement teeth 190, and the second pressure mechanism 200 and the second main engagement teeth 180 and the second pre-engagement teeth 190 may be engaged with the sleeve 140 on the radially inner side.

Furthermore, in another embodiment, one of two gears provided in parallel may be provided with a sleeve and the other of the two gears may be provided with main engagement teeth, pre-engagement teeth, and a pressure mechanism.

### 7. Effects of Various Embodiments

According to the embodiment described above, only the sleeve 140 is moved via the shift fork F by the actuator. In other words, the sleeve 140 is the only member that moves in the direction of the central axis 113 of the rotary shaft 110. Accordingly, the total mass of the movable component is reduced. As a result, it is possible to significantly reduce the electric power consumption of the actuator-driving motor based on a decrease in inertia.

In addition, the sleeve 140 performing the pre-engagement and the main engagement is directly assembled to the rotary shaft 110. Further, the first rotation absorption mechanism (the first pre-engagement teeth 160, the first main engagement teeth 150, and the first pressure mechanism 170) is directly assembled to the first gear 120 and/or the second rotation absorption mechanism (the second pre-engagement teeth 190, the second main engagement teeth 180, and the second pressure mechanism 200) is directly assembled to the second gear 130. As a result, it is possible to suppress a situation in which the sleeve 140, the first rotation absorption mechanism, and/or the second rotation absorption mechanism generates shaft runout. As a result, it is possible to improve the robustness during engagement between the rotary shaft 110 and the first gear 120 and/or the robustness during engagement between the rotary shaft 110 and the second gear 130.

Further, the pre-engagement teeth and the main engagement teeth in each rotation absorption mechanism have a simple shape, and thus the pre-engagement teeth and the main engagement teeth in each rotation absorption mechanism can be formed by means of two annular plate-shaped members. As a result, a significant reduction in machining cost and machining time can be achieved.

The first pre-engagement teeth 160 in the first rotation absorption mechanism and the second pre-engagement teeth 190 in the second rotation absorption mechanism are capable of having the same shape. Likewise, the first main engagement teeth 150 in the first rotation absorption mechanism and the second main engagement teeth 180 in the second rotation absorption mechanism are capable of having the same shape. As a result, the first pre-engagement teeth 160 and the first main engagement teeth 150 in the first rotation absorption mechanism on the HI side can be shared, without any change, as the second pre-engagement teeth 190 and the second main engagement teeth 180 in the second rotation absorption mechanism on the LOW side, respectively. As a result, a significant reduction in machining cost and machining time can be achieved.

Furthermore, both the pre-engagement teeth and the main engagement teeth in each rotation absorption mechanism are formed by an annular member and have external teeth on the outer peripheries of the teeth. These external teeth are capable of meshing with the internal teeth formed on the inner peripheral surface of the sleeve. As a result, each of the pre-engagement teeth, each of the main engagement teeth, and the sleeve can be increased in diameter, and thus a decrease in axial engagement length and a decrease in engagement time (responsiveness improvement) are possible.

Furthermore, the first gear 120 is capable of having the second communication bore 124 through which the lubricating oil passes at a position facing the first pre-engagement teeth 160, and thus the lubricating oil that has received a centrifugal force is capable of intruding between the first pre-engagement teeth 160 and the first main engagement teeth 150. In addition, the friction plate between the first pre-engagement teeth 160 and the first main engagement teeth 150 is exposed to the outside. As a result, the lubricating oil that has intruded between the first pre-engagement teeth 160 and the first main engagement teeth 150 is capable of easily escaping to the outside, and thus it is possible to improve the durability of the friction plate and achieve an increase in synchronization capacity attributable to spring force improvement.

The same applies to the second gear 130. In other words, the second gear 130 is capable of having the fourth communication bore 134 through which the lubricating oil passes at a position facing the second pre-engagement teeth 190, and thus the lubricating oil that has received a centrifugal force is capable of intruding between the second pre-engagement teeth 190 and the second main engagement teeth 180. In addition, the friction plate between the second pre-engagement teeth 190 and the second main engagement teeth 180 is exposed to the outside. As a result, the lubricating oil that has intruded between the second pre-engagement teeth 190 and the second main engagement teeth 180 is capable of easily escaping to the outside, and thus it is possible to improve the durability of the friction plate and achieve an increase in synchronization capacity attributable to spring force improvement.

Furthermore, a novel configuration is provided in which the first pre-engagement teeth 160 capable of rotating relative to the first gear 120 simply by the outer peripheral surface 122a of the first gear 120 being inserted through the first pre-engagement teeth 160 are pressed toward the first main engagement teeth 150 by the pressure member 173 meshing with the outer peripheral surface 122a of the first gear 120 and rotating integrally with the first gear 120 at all times with respect to the first main engagement teeth 150 meshing with the outer peripheral surface 122a of the first gear 120 and rotating integrally with the first gear 120 at all times. In this configuration, it is possible to rotate the first pre-engagement teeth 160 integrally with the rotary shaft 110 by the sleeve 140 moving along the central axis 113 of the rotary shaft 110 and meshing with the first pre-engagement teeth 160 and rotate the first main engagement teeth 150 integrally with the rotary shaft 110 by the sleeve 140 moving along the central axis 113 of the rotary shaft 110 and meshing with the first main engagement teeth 150.

The same applies to the second gear 130. In other words, a novel configuration is provided in which the second pre-engagement teeth 190 capable of rotating relative to the second gear 130 simply by the outer peripheral surface 132a of the second gear 130 being inserted through the second pre-engagement teeth 190 are pressed toward the second main engagement teeth 180 by the pressure member 203 meshing with the outer peripheral surface 132a of the second gear 130 and rotating integrally with the second gear 130 at all times with respect to the second main engagement teeth 180 meshing with the outer peripheral surface 132a of the second gear 130 and rotating integrally with the second gear 130. In this configuration, it is possible to rotate the second pre-engagement teeth 190 integrally with the rotary shaft 110 by the sleeve 140 moving along the central axis 113 of the rotary shaft 110 and meshing with the second pre-engagement teeth 190 and rotate the second main engagement teeth 180 integrally with the rotary shaft 110 by the sleeve 140 moving along the central axis 113 of the rotary shaft 110 and meshing with the second main engagement teeth 180.

### 8. Regarding Drag Torque Estimation and Motor Torque Correction

Described below is a case where the drag torque of the motor is estimated and the torque of the motor is corrected based on the estimated drag torque when the motor is used as a prime mover that supplies power to the rotary shaft 110 in the various embodiments described above.

JP 2014-136491A (hereinafter, referred to as “Reference A”) discloses a technique for reducing a speed change shock by outputting a torque offsetting the inertia torque of an engine from a motor. JP 9-331603A (hereinafter, referred to as “Reference B”) discloses a technique for reducing a speed change shock attributable to the inertia torque of a motor by correcting the torque of the motor such that the inertia torque is offset from the torque of the motor.

The techniques disclosed in References A and B are for inertia torque estimation from motor rotation fluctuations. Accordingly, in a case where a change in motor rotation is not stable due to disturbance or vehicle vibration, it is difficult to appropriately correct the torque of the motor with the techniques. Further, since the techniques disclosed in References A and B are for inertia torque estimation from motor rotation fluctuations, it is difficult to accurately calculate the torque of the motor to be corrected in a case where the relationship between the torque of the motor and the motor rotation fluctuations has changed due to aging deterioration, individual variations, or the like.

Hereinafter, a specific example of a method for at least partially solving such a problem related to the related art described above will be described in detail.

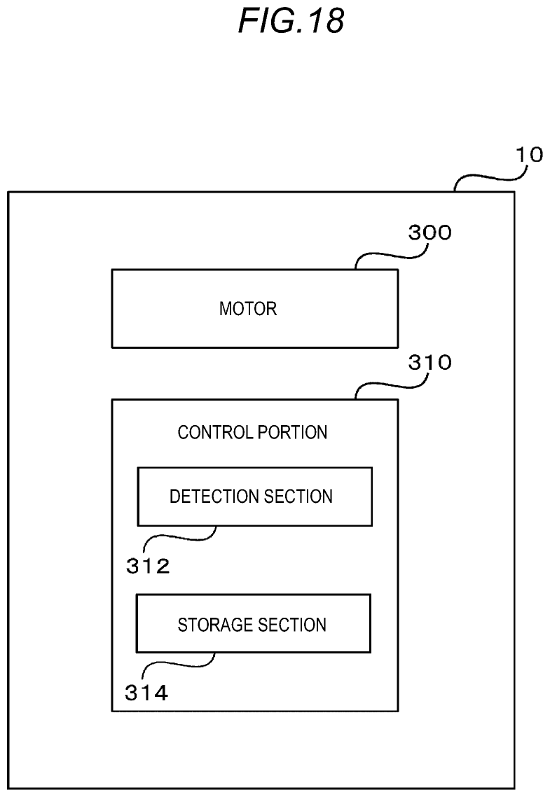

FIG. 18 is a block diagram schematically illustrating an example of a configuration that can be mounted and used in the power transmission device 10 described with reference to the drawings including FIG. 1 so that the function of estimating the drag torque of a motor and correcting the torque of the motor is realized. As illustrated in FIG. 18, the power transmission device 10 is capable of further including a motor 300 provided as a prime mover and a control portion 310 capable of performing various types of processing and control including processing for acquiring the drag torque of the motor 300 and correcting the torque of the motor 300 based on the acquired drag torque.

The rotary shaft 110 is capable of rotating by the drive force generated by the motor 300 being transmitted directly or indirectly to the rotary shaft 110 exemplified in FIG. 1.

The control portion 310 is capable of shifting the motor 300 to “stagnation state” by changing the torque of the motor 300 when the sleeve 140 is disposed at the first preparation position P₁₁ (such as the position exemplified in FIG. 11). This “stagnation state” is a state where the motor 300 maintains the rotational speed of the motor 300 or the like within a reference range for a predetermined time. The control portion 310 is capable of acquiring the torque of the motor 300 in the stagnation state as the drag torque of the motor 300 and correcting the torque of the motor 300 based on the acquired drag torque.

The control portion 310 is capable of including a detection section 312 detecting the rotational speed of the motor 300. The control portion 310 is capable of determining whether or not the motor 300 is in the stagnation state based on the rotational speed of the motor 300 detected by the detection section 312.

In addition, the control portion 310 is capable of including a storage section 314 storing the acquired drag torque of the motor 300. The control portion 310 is capable of using the drag torque stored in the storage section 314 in correcting the torque of the motor 300 by reading the drag torque stored in the storage section 314 at any timing.

The control portion 310 (including the detection section 312 and the storage section 314) can be realized by means of hardware (so-called “computer”) including, for example, a memory (not illustrated) including a main memory and an external memory storing various programs and data, a CPU (not illustrated) executing the programs stored in the memory, a communication interface (not illustrated) communicating with the motor 300, and a user interface (not illustrated) for a user to input various types of information.

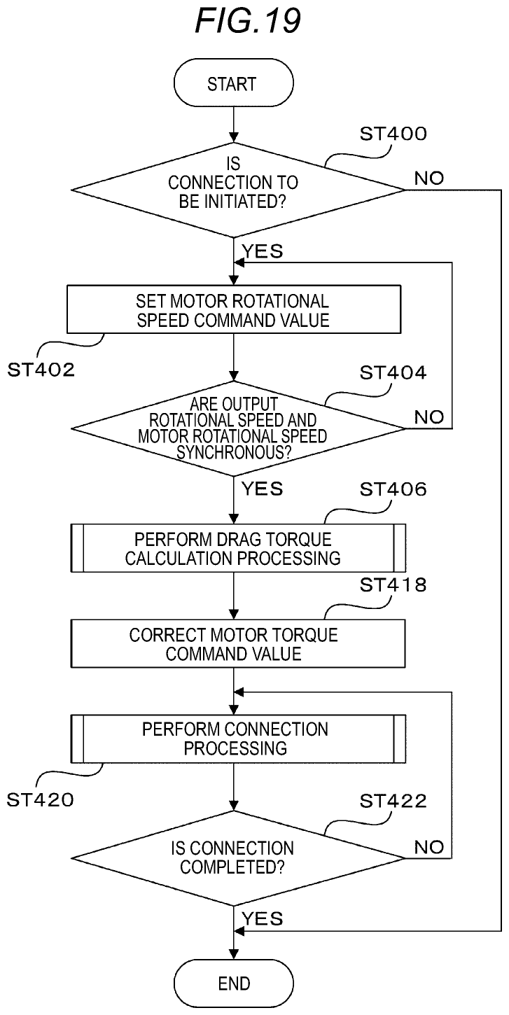

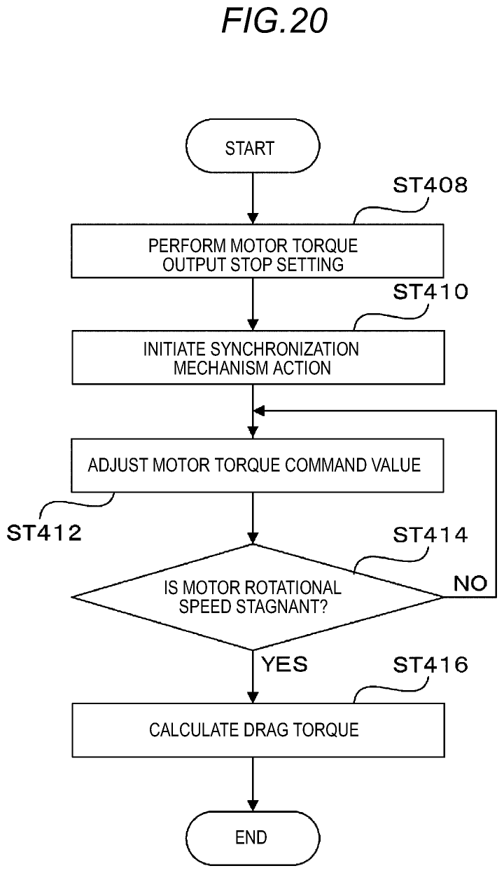

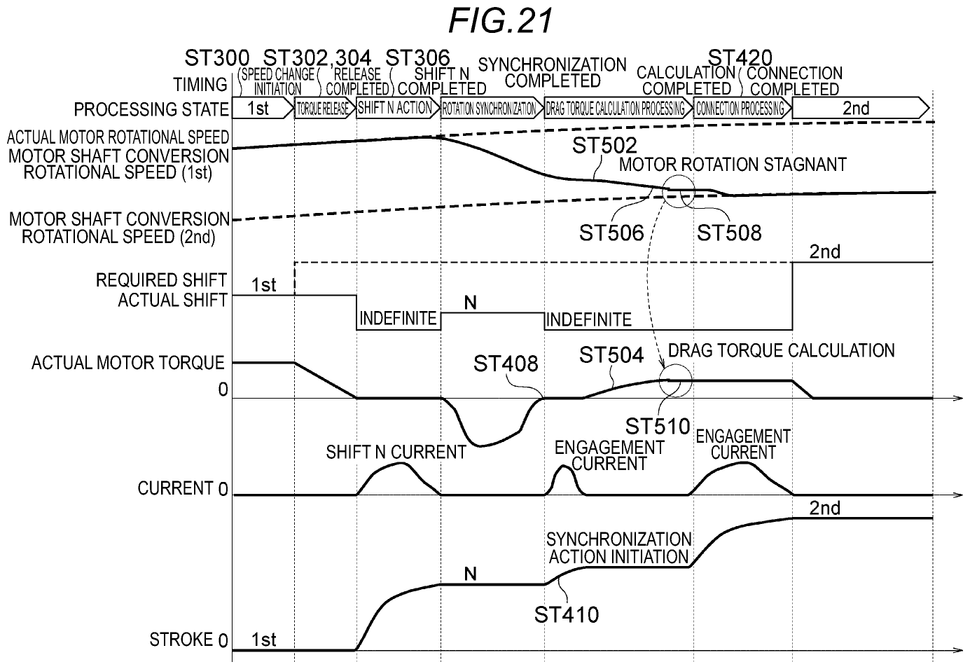

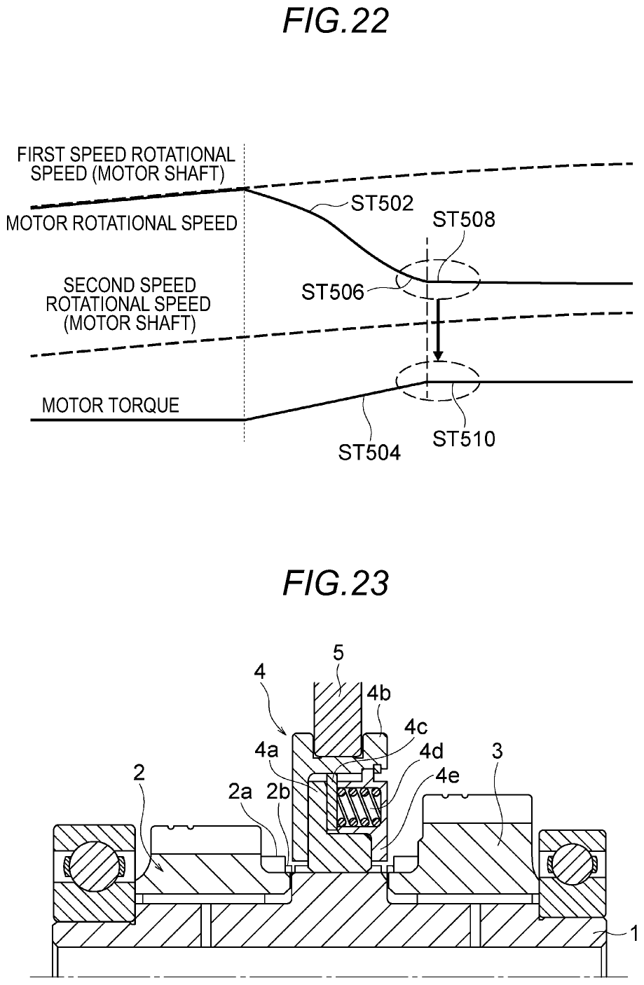

Next, an example of processing performed by the power transmission device 10 having the configuration described above will be described with reference to FIGS. 19 to 22. FIGS. 19 and 20 are flow diagrams illustrating an example of the processing executed by the power transmission device 10 illustrated in FIG. 18. FIG. 21 is a timing diagram schematically illustrating an example of the processing executed by the power transmission device 10 illustrated in FIG. 18. FIG. 22 is a diagram in which the timing diagram illustrated in FIG. 21 is enlarged in part.

Described here as an example for simplification of description is a case where speed change is performed from gear stage “LOW (first speed)” to gear stage “HI (second speed)” as described above with reference to FIG. 16 and so on. First, actions corresponding to ST300 to ST306 described with reference to FIG. 16 are executed (ST308 may be executed) before the action illustrated in FIG. 19 is initiated. The actions corresponding to ST300 to ST306 are executed at the timings denoted by the respective reference signs ST300 to ST306 also in FIG. 21.

Referring to FIG. 19, the control portion 310 or the like determines whether or not to initiate connection in ST400, which follows ST306 (or ST308) illustrated in FIG. 16. The processing is terminated in a case where it is determined that such connection is not performed. The processing proceeds to ST402 in a case where it is determined that such connection is performed.

In ST402, the control portion 310 sets a command value indicating the rotational speed of the motor 300 (here, a rotational speed corresponding to gear stage “HI (second speed)”) and transmits this command value to the motor 300. The motor 300 changes the rotational speed in accordance with the received command value.

In ST404, the control portion 310 determines whether or not the output rotational speed (the rotational speed of the output shaft (not illustrated) of the power transmission device 10) and the rotational speed of the motor 300 are synchronous with each other.

The control portion 310 is capable of identifying the output rotational speed by, for example, receiving information indicating the rotational speed of the output shaft (via the detection section 312 or the like) from a sensor (not illustrated) provided in association with the output shaft of the power transmission device 10. The control portion 310 is capable of identifying the rotational speed of the motor 300 by, for example, receiving information indicating the rotational speed of the output shaft (not illustrated) of the motor 300 (via the detection section 312 or the like) from a sensor (not illustrated) provided in association with the output shaft of the motor 300.

The processing returns to ST402 described above in a case where the control portion 310 determines in ST404 that the output rotational speed and the rotational speed of the motor 300 are not synchronous with each other. The processing proceeds to ST406 in a case where the control portion 310 determines in ST404 that the output rotational speed and the rotational speed of the motor 300 are synchronous with each other.

In ST406, the control portion 310 executes processing for calculating the drag torque of the motor 300. Such processing is illustrated as a subroutine in FIG. 20. Referring to FIG. 20, in ST408, the control portion 310 controls the motor 300 so as to stop torque output. As a result, the torque of the motor 300 becomes 0 as indicated by reference sign “ST408” in FIG. 21.

Returning to FIG. 20, in ST410, the control portion 310 initiates the action (pre-engagement) of a synchronization mechanism. Specifically, the control portion 310 controls the sleeve 140 so as to move from the initial position P_{N} (see FIG. 1) to the first preparation position P₁₁ (see FIG. 11). Then, the rotational speed of the motor 300 decreases again in ST502 as illustrated in FIG. 21. This means that the torque of the motor 300 and the drag torque of the motor 300 are not equal to each other (the torque of the motor 300 is smaller than the drag torque of the motor 300).

In this regard, in ST412, the control portion 310 sets a command value so as to change (increase and/or decrease) the rotational speed of the motor 300 (so as to increase the rotational speed of the motor 300 here) and transmits the command value to the motor 300 as illustrated in FIG. 20. Then, in ST504, the motor 300 continues to increase the torque in accordance with the received command value as illustrated in FIG. 21. As a result, the torque of the motor 300 increases and approaches the drag torque of the torque of the motor 300, and thus the decrease in the rotational speed of the motor 300 becomes moderate in ST506, which is schematically illustrated in an enlarged manner in FIG. 22.

As illustrated in FIG. 22, the motor 300 shifts to a state where the rotational speed of the motor 300 is stagnant (stagnation state) in ST508 when the torque of the motor 300 increases. It can be said that the torque of the motor 300 and the drag torque of the motor 300 are substantially the same in such a stagnation state.

The control portion 310 is capable of determining that the motor 300 has shifted to the stagnation state in a case where, for example, the rotational speed of the motor 300 has been maintained within a reference range for a predetermined time. In one example, the reference range can be determined by the minimum value of the rotational speed and the maximum value of the rotational speed (the minimum value and the maximum value may be the same). In another example, the reference range can be determined by the minimum value of the amount by which the rotational speed changes and the maximum value of the amount by which the rotational speed changes (the maximum value and the minimum value may be the same).

Returning to FIG. 20, in ST414, the control portion 310 determines whether or not the motor 300 has shifted to the stagnation state (whether or not the rotational speed of the motor 300 has been maintained within the reference range for a predetermined time). The processing returns to ST412 in a case where it is determined that the motor 300 has not shifted to the stagnation state. The processing proceeds to ST416 in a case where it is determined that the motor 300 has shifted to the stagnation state.

In ST416, the control portion 310 controls the motor 300 so as to maintain the torque at that point in time. As a result, in ST510 (see FIGS. 21 and 22), the motor 300 maintains the torque to be output substantially constant. Further, in ST416, the control portion 310 is capable of acquiring the torque to be output at the point in time when the motor 300 has shifted to the stagnation state as the drag torque of the motor 300 and storing the acquired drag torque in the storage section 314.

Next, the processing returns from the subroutine illustrated in FIG. 20 to the main routine illustrated in FIG. 19. Referring to FIG. 19, in ST418, the control portion 310 is capable of correcting the torque to be commanded to the motor 300 (torque to be output to the motor 300) based on the drag torque acquired in ST416. For example, the control portion 310 is capable of comparing the previously and currently acquired drag torque values and increasing (or decreasing) the torque to be output to the motor 300 in a case where the drag torque of the motor 300 has increased (or decreased) due to the aging deterioration of, for example, various components and members included in the power transmission device 10, a change in temperature in the environment in which the power transmission device 10 is disposed, and/or the like.

Next, in ST420, the control portion 310 executes connection processing (main engagement). During this connection processing, the sleeve 140 (is controlled by the control portion 310 and) moves from the first preparation position P₁₁ (see FIG. 11) to the first switching position P₁₂ (see FIG. 12). At this point in time, the motor 300 outputs a torque corrected (by the control portion 310) so as to offset the drag torque, which results in a state where substantially no torque is applied to the rotary shaft 110 with which the sleeve 140 is engaged (state where the drag torque of the motor 300 is offset by the torque output by the motor 300). As a result, during the main engagement, the sleeve 140 is capable of smoothly moving from the first preparation position P₁₁ (see FIG. 11) to the first switching position P₁₂ (see FIG. 12) while suppressing shock generation.

Next, in ST422, the control portion 310 determines whether or not the connection processing (main engagement) has been completed. The processing returns to ST420 in a case where it is determined that the connection processing has yet to be completed. The processing is terminated in a case where it is determined that the connection processing has been completed.

Although an example in which the drag torque of the motor 300 is calculated (acquired) every time a change in speed is performed from one gear stage to another gear stage is illustrated in FIGS. 19 to 21, it is possible to calculate (acquire) the drag torque of the motor 300 at a predetermined frequency. In this case, the drag torque acquired at the point in time of a certain change in speed and/or the torque of the motor 300 corrected based on this drag torque can be kept as a learning value and the learning value kept as described above can be used, without new drag torque acquisition (calculation), at the point in time of a subsequent change in speed. As a result, it is possible to execute a change in speed more quickly and easily than in a case where the drag torque is calculated (acquired) at each change in speed.

Although an example in which a change in speed and correction of the torque of the motor 300 based on the acquired drag torque are collectively performed is illustrated in FIGS. 19 to 21, it is also possible to execute the processing for correcting the torque of the motor 300 based on the acquired drag torque at another timing after collectively performing the change in speed and the drag torque acquisition.

The “drag torque” that has been described in the present specification is capable of including the inertia torque of the motor 300 and/or (the torque corresponding to) a mechanical loss at which the power transmission device 10 affects the rotation of the motor 300.

The inertia torque of the motor 300 can be changed due to the aging deterioration of a member (such as a magnet) mounted on the motor 300. In addition, (the torque corresponding to) the mechanical loss at which the power transmission device 10 affects the rotation of the motor 300 can be changed due to the aging deterioration of components and members constituting the power transmission device 10. Such components and members are capable of including, for example and without limitation, the friction plate 165 disposed between the first main engagement teeth 150 and the first pre-engagement teeth 160, the friction plate 195 disposed between the second main engagement teeth 180 and the second pre-engagement teeth 190, the bearing 119a disposed between the rotary shaft 110 and the first gear 120, and/or the bearing 119b disposed between the rotary shaft 110 and the second gear 130.

In addition, the inertia torque of the motor 300 and/or (the torque corresponding to) the mechanical loss at which the power transmission device 10 affects the rotation of the motor 300 is capable of varying with the temperature change of the environment in which the power transmission device 10 is disposed. The temperature of the above-described lubricating oil used in the power transmission device 10 can be used as an example of the temperature of the environment in which the power transmission device 10 is disposed. The temperature of this lubricating oil can be detected by, for example, an oil temperature sensor (not illustrated) provided inside or outside the power transmission device 10 and detecting the temperature of the lubricating oil. The viscosity of the lubricating oil increases (or decreases) as the oil temperature detected by the oil temperature sensor decreases (or increases), and thus the drag torque of the motor 300 is capable of increasing (or decreasing) as the oil temperature detected by the oil temperature sensor decreases (or increases). Further, (in a case where a permanent magnet is used for the motor 300) the magnetic force of the permanent magnet used for the motor 300 increases (or decreases) as the oil temperature detected by the oil temperature sensor decreases (or increases), and thus the drag torque of the motor 300 attributable to cogging is capable of increasing (or decreasing) as the oil temperature detected by the oil temperature sensor decreases (or increases).

As described above, the rotation of the motor 300 is stabilized by means of the synchronization mechanism (pre-engagement). Accordingly, the drag torque of the motor 300 can be acquired as to torque fluctuations within a synchronization capacity.

In addition, since the rotation of the motor 300 is stabilized by means of the synchronization mechanism (pre-engagement), the drag torque of the motor 300 can be acquired more quickly than in a case where the motor 300 is used alone.

Further, the presence or absence of shifting of the motor 300 to the stagnation state entailed by a change in the torque output from the motor 300 is detected even in a case where the drag torque of the motor 300 has changed due to, for example, the aging deterioration of components and members constituting the power transmission device 10. Accordingly, the drag torque of the motor 300 can be acquired with accuracy.

Furthermore, the drag torque of the motor 300 can be acquired during a change in speed in the power transmission mechanism (there are many acquisition and learning opportunities), and thus the drag torque of the motor 300 can be acquired at substantially any timing.

There is no need to store a characteristic map or the like for each region of rotation, and thus it is possible to acquire the drag torque of the motor 300 and/or execute the connection processing by simpler control.

### 9. Various Aspects

A power transmission device according to a first aspect includes a first rotating member configured to be rotated by power transmitted from a prime mover, a second rotating member configured to rotate relative to the first rotating member, a first engagement member configured to rotate integrally with the second rotating member at all times, a second engagement member configured to be pressed toward the first engagement member, and a moving member configured to rotate integrally with the first rotating member at all times, be separated from the first engagement member and the second engagement member at an initial position, mesh with the second engagement member to cause the second engagement member to rotate integrally with the first rotating member at a first preparation position where the moving member has moved in an axial direction of the first rotating member from the initial position by receiving an external force, and cause the second rotating member to rotate integrally with the first rotating member by meshing with the first engagement member and causing the first engagement member to rotate integrally with the first rotating member at a first switching position where the moving member has moved in the axial direction of the first rotating member from the first preparation position by receiving an external force.

In the power transmission device according to a second aspect according to the first aspect described above, both the first engagement member and the second engagement member may be annular plate-shaped members.

The power transmission device according to a third aspect according to the first aspect described above or the second aspect described above may further include a third rotating member configured to rotate relative to the first rotating member with the moving member sandwiched between the second rotating member and the third rotating member, a third engagement member configured to rotate integrally with the third rotating member at all times, and a fourth engagement member configured to be pressed toward the third engagement member. The moving member may be configured to be separated from the third engagement member and the fourth engagement member at the initial position, mesh with the fourth engagement member to cause the fourth engagement member to rotate integrally with the first rotating member at a second preparation position where the moving member has moved in an axial direction of the third rotating member from the initial position by receiving an external force, and cause the third rotating member to rotate integrally with the first rotating member by meshing with the third engagement member and causing the third engagement member to rotate integrally with the first rotating member at a second switching position where the moving member has moved in the axial direction of the third rotating member from the second preparation position by receiving an external force. The third engagement member and the fourth engagement member may be respectively identical in shape to the first engagement member and the second engagement member. The third engagement member and the fourth engagement member may be disposed such that the third engagement member and the first engagement member face each other with the same surface and the fourth engagement member and the second engagement member face each other with the same surface.

In the power transmission device according to a fourth aspect according to any one of the first to third aspects described above, the moving member may have an annular shape and have, on an inner peripheral surface, internal teeth meshing with external teeth formed on an outer peripheral surface of the first rotating member, the first engagement member may have first external teeth formed on an outer peripheral surface and meshing with the internal teeth of the moving member, and the second engagement member may have second external teeth formed on an outer peripheral surface and meshing with the internal teeth of the moving member.

In the power transmission device according to a fifth aspect according to any one of the first to fourth aspects described above, the first rotating member may have an inner region extending along a central axis of the first rotating member and accommodating lubricating oil and a first communication bore allowing the inner region and an outer peripheral surface to communicate with each other, the second rotating member may have a second communication bore allowing an inner peripheral surface extending while facing the outer peripheral surface of the first rotating member and an outer peripheral surface extending while facing the second engagement member to communicate with each other, and the lubricating oil accommodated in the inner region may be allowed to intrude between the first engagement member and the second engagement member through the first communication bore, a gap between the outer peripheral surface of the first rotating member and the inner peripheral surface of the second rotating member, and the second communication bore by receiving a centrifugal force.

In the power transmission device according to a sixth aspect according to any one of the first to fifth aspects described above, the first engagement member may be spline-coupled to the second rotating member, the second engagement member may be provided so as to be rotatable relative to the second rotating member, and the power transmission device may further include a pressure member spline-coupled to the second rotating member so as to be movable in the axial direction of the first rotating member and pressing the second engagement member toward the first engagement member by being biased by an elastic member.

In the power transmission device according to a seventh aspect according to any one of the first to sixth aspects described above, the second engagement member may be rotatable integrally with the first engagement member by being pressed toward the first engagement member when the moving member is at the initial position.

The power transmission device according to an eighth aspect according to any one of the first to seventh aspects described above may further include a motor provided as the prime mover and a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

In the power transmission device according to a ninth aspect according to the eighth aspect described above, the control portion may correct the torque of the motor based on the stored drag torque.

In the power transmission device according to a tenth aspect according to the eighth aspect described above or the ninth aspect described above, the drag torque of the motor may be changed due to aging deterioration of a member selected from a group including a friction plate disposed between the first engagement member and the second engagement member, a bearing disposed between the first rotating member and the second rotating member, and a magnet mounted on the motor.

In the power transmission device according to an eleventh aspect according to any one of the eighth to tenth aspects described above, the drag torque of the motor may vary with a temperature of an environment in which the power transmission device is disposed and increase as the temperature decreases.

The power transmission device according to a twelfth aspect according to any one of the eighth to eleventh aspects described above may further include a detection section detecting a rotational speed of the motor.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A power transmission device comprising:
a first rotating member configured to be rotated by power transmitted from a prime mover;
a second rotating member configured to rotate relative to the first rotating member;
a first engagement member configured to rotate integrally with the second rotating member at all times;
a second engagement member configured to be pressed toward the first engagement member; and
a moving member configured to
rotate integrally with the first rotating member at all times,
be separated from the first engagement member and the second engagement member at an initial position,
mesh with the second engagement member to cause the second engagement member to rotate integrally with the first rotating member at a first preparation position where the moving member has moved in an axial direction of the first rotating member from the initial position by receiving an external force, and
cause the second rotating member to rotate integrally with the first rotating member by meshing with the first engagement member and causing the first engagement member to rotate integrally with the first rotating member at a first switching position where the moving member has moved in the axial direction of the first rotating member from the first preparation position by receiving an external force.

2. The power transmission device according to claim 1, wherein
both the first engagement member and the second engagement member are annular plate-shaped members.

3. The power transmission device according to claim 2, further comprising:
a third rotating member configured to rotate relative to the first rotating member with the moving member sandwiched between the second rotating member and the third rotating member;
a third engagement member configured to rotate integrally with the third rotating member at all times; and
a fourth engagement member configured to be pressed toward the third engagement member, wherein
the moving member is configured to
be separated from the third engagement member and the fourth engagement member at the initial position
mesh with the fourth engagement member to cause the fourth engagement member to rotate integrally with the first rotating member at a second preparation position where the moving member has moved in an axial direction of the third rotating member from the initial position by receiving an external force, and
cause the third rotating member to rotate integrally with the first rotating member by meshing with the third engagement member and causing the third engagement member to rotate integrally with the first rotating member at a second switching position where the moving member has moved in the axial direction of the third rotating member from the second preparation position by receiving an external force,
the third engagement member and the fourth engagement member are respectively identical in shape to the first engagement member and the second engagement member, and
the third engagement member and the fourth engagement member are disposed such that the third engagement member and the first engagement member face each other with the same surface and the fourth engagement member and the second engagement member face each other with the same surface.

4. The power transmission device according to claim 3, wherein
the moving member has an annular shape and has, on an inner peripheral surface, internal teeth meshing with external teeth formed on an outer peripheral surface of the first rotating member,
the first engagement member has first external teeth formed on an outer peripheral surface and meshing with the internal teeth of the moving member, and
the second engagement member has second external teeth formed on an outer peripheral surface and meshing with the internal teeth of the moving member.

5. The power transmission device according to claim 4, wherein
the first rotating member has an inner region extending along a central axis of the first rotating member and accommodating lubricating oil and a first communication bore allowing the inner region and the outer peripheral surface to communicate with each other,
the second rotating member has a second communication bore allowing an inner peripheral surface extending while facing the outer peripheral surface of the first rotating member and an outer peripheral surface extending while facing the second engagement member to communicate with each other, and
the lubricating oil accommodated in the inner region is allowed to intrude between the first engagement member and the second engagement member through the first communication bore, a gap between the outer peripheral surface of the first rotating member and the inner peripheral surface of the second rotating member, and the second communication bore by receiving a centrifugal force.

6. The power transmission device according to claim 5, wherein
the first engagement member is spline-coupled to the second rotating member,
the second engagement member is provided so as to be rotatable relative to the second rotating member, and
the power transmission device further comprises a pressure member spline-coupled to the second rotating member so as to be movable in the axial direction of the first rotating member and pressing the second engagement member toward the first engagement member by being biased by an elastic member.

7. The power transmission device according to claim 6, further comprising:
a motor provided as the prime mover; and
a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

8. The power transmission device according to claim 7, wherein
the drag torque of the motor varies with a temperature of an environment in which the power transmission device is disposed and increases as the temperature decreases.

9. The power transmission device according to claim 2, further comprising:
a motor provided as the prime mover; and
a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

10. The power transmission device according to claim 9, wherein
the drag torque of the motor varies with a temperature of an environment in which the power transmission device is disposed and increases as the temperature decreases.

11. The power transmission device according to claim 1, further comprising:
a third rotating member configured to rotate relative to the first rotating member with the moving member sandwiched between the second rotating member and the third rotating member;
a third engagement member configured to rotate integrally with the third rotating member at all times; and
a fourth engagement member configured to be pressed toward the third engagement member, wherein
the moving member is configured to
be separated from the third engagement member and the fourth engagement member at the initial position
mesh with the fourth engagement member to cause the fourth engagement member to rotate integrally with the first rotating member at a second preparation position where the moving member has moved in an axial direction of the third rotating member from the initial position by receiving an external force, and
cause the third rotating member to rotate integrally with the first rotating member by meshing with the third engagement member and causing the third engagement member to rotate integrally with the first rotating member at a second switching position where the moving member has moved in the axial direction of the third rotating member from the second preparation position by receiving an external force,
the third engagement member and the fourth engagement member are respectively identical in shape to the first engagement member and the second engagement member, and
the third engagement member and the fourth engagement member are disposed such that the third engagement member and the first engagement member face each other with the same surface and the fourth engagement member and the second engagement member face each other with the same surface.

12. The power transmission device according to claim 11, further comprising:
a motor provided as the prime mover; and
a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

13. The power transmission device according to claim 12, wherein
the drag torque of the motor varies with a temperature of an environment in which the power transmission device is disposed and increases as the temperature decreases.

14. The power transmission device according to claim 1, wherein
the moving member has an annular shape and has, on an inner peripheral surface, internal teeth meshing with external teeth formed on an outer peripheral surface of the first rotating member,
the first engagement member has first external teeth formed on an outer peripheral surface and meshing with the internal teeth of the moving member, and
the second engagement member has second external teeth formed on an outer peripheral surface and meshing with the internal teeth of the moving member.

15. The power transmission device according to claim 14, further comprising:
a motor provided as the prime mover; and
a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

16. The power transmission device according to claim 15, wherein
the drag torque of the motor varies with a temperature of an environment in which the power transmission device is disposed and increases as the temperature decreases.

17. The power transmission device according to claim 1, wherein
the first rotating member has an inner region extending along a central axis of the first rotating member and accommodating lubricating oil and a first communication bore allowing the inner region and the outer peripheral surface to communicate with each other,
the second rotating member has a second communication bore allowing an inner peripheral surface extending while facing the outer peripheral surface of the first rotating member and an outer peripheral surface extending while facing the second engagement member to communicate with each other, and
the lubricating oil accommodated in the inner region is allowed to intrude between the first engagement member and the second engagement member through the first communication bore, a gap between the outer peripheral surface of the first rotating member and the inner peripheral surface of the second rotating member, and the second communication bore by receiving a centrifugal force.

18. The power transmission device according to claim 1, wherein
the first engagement member is spline-coupled to the second rotating member,
the second engagement member is provided so as to be rotatable relative to the second rotating member, and
the power transmission device further comprises a pressure member spline-coupled to the second rotating member so as to be movable in the axial direction of the first rotating member and pressing the second engagement member toward the first engagement member by being biased by an elastic member.

19. The power transmission device according to claim 1, further comprising:
a motor provided as the prime mover; and
a control portion configured to store torque of the motor in a stagnation state as drag torque of the motor, regarding the stagnation state where the motor maintains a rotational speed within a reference range for a predetermined time due to a change in the torque of the motor, when the moving member is disposed at the first preparation position.

20. The power transmission device according to claim 19, wherein
the drag torque of the motor varies with a temperature of an environment in which the power transmission device is disposed and increases as the temperature decreases.
